(19) United States
(12) Patent Application Publication
(10) Pub. No.: US 2011/0303027 A1
(43) Pub. Date: Dec. 15, 2011

(54) SYSTEMS AND METHODS FOR PROCESSING SENSOR MODULES

(75) Inventors: Mohsen Shirazi, San Jose, CA (US); John A. Mundaden, Pleasanton, CA (US); Scott A. Perrault, Antelope, CA (US)

(73) Assignee: Affymetrix, Inc., Santa Clara, CA (US)

(21) Appl. No.: 13/157,268

(22) Filed: Jun. 9, 2011

Related U.S. Application Data
(60) Provisional application No. 61/353,369, filed on Jun. 10, 2010.

(51) Int. Cl. G01D 21/00; B32B 38/08; B23P 17/00; B23P 11/00; B23P 11/02

(52) U.S. Cl. 73/866.5; 29/428; 29/453; 29/464; 156/64

(57) ABSTRACT

The invention provides methods and components for assembly of arrays of sensors from modular units containing component sensors of the array. The methods are particularly useful for forming arrays of microarrays. The sensor modules can readily be assembled in different combinations thereby allowing many different modular sensor arrays to be assembled from the same building blocks. Such modular sensor arrays offer advantages of economies of scale for a manufacturer of the modular units and flexibility for an end user in allowing the user to customize the array of sensor according to the user's own needs from a relatively small number of sensor modules provided by the manufacturer.

### CROSS-REFERENCES TO RELATED APPLICATIONS

The present application is a nonprovisional of 61/353,369 filed Jun. 10, 2010, incorporated by reference in its entirety for all purposes.

### FIELD OF THE INVENTION

The invention resides in the field of sensors, such as microarrays, for analyzing samples, and more particularly modular arrays of such sensors for simultaneous processing and analyses of multiple sensors.

### BACKGROUND OF THE INVENTION

Probe arrays, particularly microarrays, such as the GeneChip® array have wide ranging applications in the pharmaceutical, biotechnology and medical industries. In general, a probe array is exposed to a sample, such that probes bind to analytes or targets (if any) in the sample to which the probes have affinity. The probe arrays are then scanned to determine to which probes the target(s) in the sample have hybridized. The identity of the probes hybridized to the sample provides various information regarding the target(s) in the sample. For example, arrays are useful for sequencing target nucleic acids, expression monitoring, detecting mutations in targets, or simply detecting the presence of a target (e.g., of a particular pathogen).

The first commercial microarray products were in the form of individual arrays. Thus, each array was processed and analyzed separately. More recently, microarray products have been made available as sensor plates having an array of microarray sensors attached to the same support. Usually the arrays present on the same support are multiple copies of the same type of microarray. Although sensor plates allow for simultaneous analysis and high-throughput processing of multiple samples with the same type of microarray, the composition of such sample plates is determined in advance by the manufacturer and may not match the needs of a particular user. Thus, a particular user may not have sufficient samples to use all the arrays on a sample plate, or may need to use multiple sample plates if interested in analyzing sample(s) with different arrays.

This following commonly-assigned applications disclose related subject matter: U.S. Patent Application No. 61/267,738, filed Dec. 8, 2009 by Mohsen Shirazi and titled “Manufacturing and Processing Polymer Arrays;” U.S. Patent Application No. 61/164,345, Client Reference No. 3868, filed Mar. 27, 2009 and titled “System and Methods for Processing Microarrays;” U.S. patent application Ser. No. 11/243,621 (published as 3006-088863), filed on Oct. 4, 2005; U.S. Patent Application No. 60/703,706, filed on Jul. 29, 2005; U.S. Patent Application No. 60/623,191, filed on Oct. 29, 2004; U.S. patent application Ser. No. 10/826,577, filed on Apr. 16, 2004; and U.S. Patent Application No. 60/463,563, filed on Apr. 16, 2003.

### BRIEF SUMMARY OF THE INVENTION

The invention generally provides improved devices, systems, and methods for analyzing samples with sensors or probe arrays, particularly for performing an assay analysis with an array of sensors. Embodiments of the invention may be useful for a user performing simultaneous analysis of an array of sensors with high-throughput (HT) analysis equipment, particularly for a low-throughput (LT) end user. The invention provides sensor modules that when assembled with a frame, form a sensor plate having an array of sensors for use in an assay process. In one aspect of the invention, the modular sensor plate assembly allows an end user to assemble a sensor plate with one or more sensor modules. The sensor modules may be of the same type of sensor or may include different types of sensor modules. This aspect of the invention allows for customizable sensor plates that may be especially useful for an end user having a limited number of samples or requiring different types of sensors within one sensor plate. An exemplary sensor module has a rectangular base portion having a row of 8 evenly spaced sensors along one side. The sensors extend away from the base portion so that when the sensor module is attached to the frame in the sensor plate assembly, each sensor can be separately processed in an assay process, such as hybridization conducted in a hybridization tray. Ideally, the sensors are spaced on the sensor module such that 12 modules placed on a rectangular frame forms a 12 sensor by 8 sensor rectangular array to facilitate analysis with standard processing trays on a HT analysis equipment. By allowing customization of a sensor array plate with individually selected sensor modules, the invention generally increases the efficiency of assay processing for an end user, an LT end user in particular.

In a first aspect, the invention provides a modular sensor array plate assembly for use with an automated sensor array analyzer and a processing tray. The sensor array assembly includes a plurality of sensor modules and a frame engageable with the sensor modules. The sensor modules may be used separately in a low throughput analyzer or may be attached to the frame to form a sensor plate for analysis with HT analysis equipment. Each sensor module includes at least one sensor and a solid support having a coupling surface by which the module is fixedly attached to the frame in a fixed pre-determined alignment relative to the frame. Each sensor extends along a major plane of the frame and protrudes from the solid support of the module sufficiently to facilitate processing of the sensors in a processing tray. Processing of the sensors in a processing tray entails dipping or placing the sensor array plate onto the processing tray such that each sensor contacts a fluid in a separate well or reservoir of a processing tray, such as a hybridization tray.

In many embodiments, the solid support will include a base portion in the shape of a rectangular prism and the sensors protrude from a top surface of the rectangular prism in a row of square peg-like protrusions. Preferably, the sensors of a row are microarray chips distributed along a common axis and spaced approximately 9 mm apart, while the frame fixedly receives 12 sensor modules so as to form a rectangular array of sensors for use with a standard processing tray. The sensors generally protrude a distance from a base portion of the solid support that ranges from 1 mm to 30 mm and are disposed on a flat surface of a portion of the solid support that protrudes from the base portion. In some embodiments, the sensor modules will include sensor module covers affixable to each sensor module so as to protect the sensors attached to the solid support.

The sensor module attaches to the frame by a coupling surface on the base portion of the solid support. The coupling surface may attached the module to the frame in a variety of ways, including snaps, protrusions, recesses, undercuts or nesting surfaces, pressure-sensitive adhesives, and UV curable adhesives. The coupling surface of the sensor module will generally correspond to a coupling surface of the frame that receives the module and may be releasable or non-releasable. For example, the coupling surface of the frame can be one or more hexagonal holes and the coupling surface on the frame one or more round pins engageable with the hexagonal holes or vice versa. A snap sensor module will snap onto or resiliently displace a snap surface of the frame.

The coupling surface of the sensor module corresponds to a coupling surface of the frame or an adjacent module. Snapping of the module into a fixed position is effected by a resilient return of the snap surface toward a relaxed configuration. An undercut of a nesting sensor module will nest onto or within the members of a frame. Often a nesting module will also have a coupling surface that interfaces with a retaining member, such as a rim placed over the frame or a backing attached on the underside of the frame. In some embodiments, the solid support of the sensor module has multiple coupling surfaces that interface with a plurality of surfaces of the frame, such that when interfaced, the surfaces act together to constrain the movement of the sensor modules relative to the frame in each direction. A peel-and-stick sensor module may have an adhesive coupling surface, such as a layer of pressure-sensitive adhesive, disposed on the bottom of the solid support opposite the sensors and covered with a disposable backing. In another embodiment, a sensor module may include two protrusions or circular pegs that fit into two corresponding wells of the frame, the wells filled with an adhesive to fixedly attach the sensor module to the frame. Ideally, the adhesive in the wells is a UV curable adhesive that may be cured through a transparent portion of the frame. In any of the embodiments, corresponding coupling surfaces of the frame and the modules may include various shapes, including corresponding surfaces of different shapes. In some embodiments, the coupling surfaces interface with a high interference tolerance so as to permanently fix the module to the frame.

The sensor modules further include an alignment feature or features on the solid support, either as a separate feature or incorporated into the coupling surface. The alignment feature interfaces with a corresponding alignment feature of the frame or an adjacent module. Aligning the modules includes fixing their orientation according to a pre-determined alignment so that the sensors of the module form an array that can be processed as a sensor array plate. The alignment features may align the sensor modules to the frame in a variety of ways, including notches, protrusions, and recesses. A protruding notch alignment feature of a sensor module interfaces with or is fittingly received by a corresponding notched recess alignment feature of the frame. The alignment features are disposed on the sensor modules and the frame so that the module is in a pre-determined alignment relative to the frame when the alignment features are interfaced.

The sensor modules often include an identifying mark, such as a bar code, number or RFID, that enables a user or a machine to read or scan the mark and identify the sensor module. The identifying mark is useful as it enables the user or machine to associate the sensor module with sensors on the module or with a frame. Similarly, the frame may also include an identifying mark to be read or scanned which is associated with the sensor modules of the sensor plate assembly.

The sensor modules may be attached to the frame using an assembly press. Typically, the press has a pair of plates, one plate receiving a plurality of sensor modules and the other plate receiving the frame. In one aspect, a sensor array plate is formed by moving the plates toward each other, pressing the sensor modules and frame together. In some embodiments, the press may include a reader or detector for identifying the sensor module or frame, for example, by scanning a bar code or detecting a RFID signal. The press may also include a processor for associating an identified sensor module with the sensors of the module or with a particular frame. In certain embodiments, the press includes a curing feature to facilitate curing of an adhesive coupling surface of the sensor module, such as a heat or radiation emitting source, for example, a UV emitting LED.

In another aspect, the invention provides a method for assembling a sensor array plate from individual sensor modules and a frame. The method includes selecting a plurality of sensor modules, aligning the sensor modules to a frame according to a pre-determined alignment, and fixedly attaching the sensor modules to the frame in the pre-determined alignment. Generally, selecting the sensor modules includes selecting sensor modules having a compatible assay protocol, or at least a portion of the protocol that is compatible. Often the method includes affixing sensor module covers to individual sensor modules to protect the sensors of the sensor module. Fixedly attaching the sensor modules to the frame may include snapping the module to the frame, nesting modules within the frame, attaching a retaining member of the frame, applying pressure to a layer of pressure-sensitive adhesive, or curing a UV curable adhesive. The fixed positions of the sensor modules are aligned on the frame so that the sensors of the modules form an array of sensors, each sensor protruding from a base of the sensor module to facilitate an assay process, such as dipping each sensor of the sensor array plate into a separate reservoir of a processing tray. Ideally, the sensor plate can be processed in a HT analysis equipment that performs simultaneous analysis of each sensor, including simultaneously dipping each sensor of the sensor array plate into a separate reservoir of a processing tray.

In another aspect of the invention, the invention provides a method for assembling a sensor array plate from individual sensor modules and a frame with an assembly press. The method includes selecting a plurality of sensor modules, loading the sensor modules into the press, loading a frame into the press and operating the press to fixedly attach the sensor modules to the frame according to the pre-determined alignment. Preferably, the sensor modules are covered by sensor module covers to protect the sensors of the sensor modules. For example, the cover can have tabs at each end engageable with corresponding notches of the sensor module to snap the cover to the sensor module and hold it in place until use. The method may include attaching a sensor plate cover with the assembly press to protect the sensors of the sensor plate. Alternately, the method may include attaching an assay processing tray, packing plate or a shipping plate to the sensor plate.

### BRIEF DESCRIPTION OF THE DRAWINGS

The accompanying drawings, which are incorporated in and form a part of this specification, illustrate embodiments of the invention and, together with the description, serve to explain various aspects of the invention:

FIG. 1 schematically illustrates an exemplary array of sensors on a sensor plate assembled from sensor array modules for use in an assay process.

FIGS. 2A-2C depict an exemplary sensor plate array. FIG. 2A shows a sensor plate fitting into a processing tray. FIG. 2B shows a detail section view of a sensor of the sensor plate fitted into a well of the processing tray. FIG. 2C shows the individual components being assembled into a sensor array plate assembly.

FIGS. 3A-3D depict an exemplary snap-fit sensor module. FIGS. 3A and 3B show a three-dimensional top and bottom view of the snap-fit strip sensor module. FIGS. 3C and 3D show a bottom view and a cross-sectional view of the snap-fit sensor module.

FIGS. 4A-4F depict an exemplary snap-fit frame. FIGS. 4A and 4B show a three-dimensional view and a cross-sectional view of a snap-fit frame, respectively. FIGS. 4C and 4D show a three-dimensional and a top view of the snap-fit modules snapped to a snap-fit frame.

FIGS. 4E and 4F show a cross-sectional view of the snap-fit modules snapped into a snap-fit frame.

FIGS. 5A-5H depict an example of a snap-fit frame, snap-fit modules and a processing tray. FIGS. 5A and 5B show a top and bottom view of the snap-fit frame. FIGS. 5C and 5D show a top and bottom view of a snap-fit module. FIGS. 5E and 5F show a single snap-fit module before and after being snapped into the snap-fit frame. FIG. 5G shows 12-snap-fit modules snapped into a snap-fit frame to form a 12 by 8 array of microarrays. FIG. 5H shows the snap-fit tray fitted onto a processing tray.

FIGS. 6A-6E depict an example of a nesting or an overlapping module having an alignment feature consisting of alignment pegs. FIGS. 6A and 6B show a top and bottom view of the base of a nesting module, showing the base having undercuts and alignment pegs. FIG. 6C shows a nesting module having 8 probe arrays. FIG. 6D shows a top view of a nesting module nested into another nesting module. FIG. 6E shows the bottom view of two nesting modules nested within a frame.

FIGS. 7A-7F depict the process of attaching nesting modules to a frame. FIG. 7A shows one nesting module within a frame. FIG. 7B shows a second nesting module nested within the frame. FIG. 7C shows a third nesting module nested within the frame. FIG. 7D shows four additional nesting modules nested within the frame. FIG. 7E shows the 12 total nesting modules attached to the frame forming a 12 by 8 rectangular array of sensors. FIG. 7F shows the final sensor plate assembly including a retaining member of the frame placed over the nesting modules.

FIGS. 8A and 8B depict another example of a nesting module having an alignment feature consisting of an alignment notch.

FIGS. 9A and 9B depict an example of a nesting module before and after being nested together.

FIGS. 10A-10C depict an example of the nesting module of FIGS. 8A and 8B and a corresponding frame having protrusions for aligning the nesting modules. FIG. 10A shows a top view of the frame. FIG. 10B shows a top view of the nesting module with an alignment notch. FIG. 10C shows a bottom view of the frame.

FIGS. 11A-11H depict the process of attaching the nesting modules and the frame of FIGS. 10A-10C. FIGS. 11A and 11B illustrate the attachment of the frame to a cover. FIGS. 11C and 11D show the nesting process of the module from the bottom of the frame. FIGS. 11E and 11F show placing additional nesting modules into the frame, filling the frame. FIGS. 11G and 11H show placing a retaining member on the frame, wherein the retaining member is a backing of the frame attached to the bottom of the frame.

FIGS. 12A-12E depict an exemplary of a peel-and-stick module. FIG. 12A shows the module wherein the probe arrays are covered with a protective cover and a pre-applied adhesive strip. The adhesive strip includes an identifying mark and a peel-off label to protect the adhesive. FIG. 12B shows the peel-and-stick module with the peel-off label removed to expose the adhesive for application to the frame. FIG. 12C shows a peel-and-stick module applied to the frame. The frame has a series of protrusions corresponding to an alignment feature of the modules to align the modules during application. FIGS. 12D and 12E show a bottom view and a cross-section view, respectively, wherein the identifying mark is visible from the bottom view of the frame.

FIGS. 13A-13C depict a module and frame assembly, wherein the frame has a series of wells containing a UV adhesive that correspond to a series of pegs at each end of the module.

FIGS. 14A-14E depict the process of assembling strip modules into a frame.

FIGS. 15A-15G depict the process of assembling strip modules into a frame using a press device. FIG. 15A shows the opened press device. FIG. 15B shows a frame being loaded into the upper plate and a fixture containing the module being loaded into the lower plate. FIG. 15C shows the closed press device where the modules are pressed into the frame. FIG. 15D shows the removal of the empty fixture. FIG. 15E shows a cover loaded onto the bottom plate. FIG. 15F shows the closed press device where the cover is pressed over the module into the frame. FIG. 15G shows the press being opened and the final assembly being removed.

FIGS. 16A-16E depict the process of placing the modules into the fixture for the assembly process of FIGS. 15A to 15G and loading the fixture into the press device. FIG. 16A shows a snap-fit module having a protective cover with an identifying mark. FIG. 16B shows the snap-fit module placed in the first slot of the fixture. FIG. 16C shows filling the remaining rows of slots with snap-fit modules. FIG. 16D shows the identifying marks of each module visible through the bottom of the fixture. FIG. 16E shows the fixture loaded onto the bottom plate of the press device.

FIG. 17 depicts a simplified flowchart of a method of using a sensor module.

FIGS. 18 A-D show a side view (A), isometric view (B), bottom view (C) and close-up isometric view (D) of a strip module with a snap-coupling surface in the form of a hexagonal hole.

FIGS. 19A-C show an isometric view (A), close-up isometric view (B) and top view (C) of a frame with 3 rows and 12 columns of coupling surfaces in the form of round pins. Each column of 3 round pins couples is adapted to couple with a module having three corresponding hexagonal holes.

FIGS. 20A-D show an isometric view (A), assembly section view (B), assembly transparent view from the top (C) and close-up transparent view from the top of strip modules coupled to the frame by insertion of round pins of the frame into hexagonal holes of the strip modules.

FIGS. 21A, B show a side view (A) and an isometric view (B) of a strip module cover including snap-fit tabs to hold the cover in place over a strip module.

FIGS. 22A-D show an isometric view of the cover and strip module unassembled (A), an isometric view of the cover in place on the strip module (B), a transparent view of the cover in place on the module (C), and a close-up view of the cover in place on the strip module D.

### DETAILED DESCRIPTION OF THE INVENTION

Although the invention is described in conjunction with the exemplary embodiments, the invention is not limited to these embodiments. On the contrary, the invention encompasses alternatives, modifications and equivalents, which may be included within the spirit and scope of the invention. The invention has many embodiments and relies on many patents, applications and other references for details known to those of the art. Therefore, when a patent, application, website or other reference is cited or repeated below, the entire disclosure of the document cited is incorporated by reference in its entirety for all purposes as well as for the proposition that is recited. All documents, e.g., publications and patent applications, cited in this disclosure, including the foregoing, are incorporated herein by reference in their entireties for all purposes to the same extent as if each of the individual documents were specifically and individually indicated to be so incorporated herein by reference in its entirety. Unless otherwise apparent from the context, any element, feature, embodiment, step, aspect or the like can be used in combination with any other.

As used in this application, the singular form “a,” “an,” and “the” include plural references unless the context clearly dictates otherwise. The term “an agent,” for example, includes a plurality of agents, including mixtures thereof.

Throughout this disclosure, various aspects of this invention can be presented in a range format. When a description is provided in range format, this is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The invention may employ arrays of probes on solid substrates in some embodiments. Methods and techniques applicable to polymer (including nucleic acid and protein) array synthesis have been described in, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, and in WO 99/36760 and WO 01/58593, which are all incorporated herein by reference in their entirety for all purposes. Patents that describe synthesis techniques include U.S. Pat. Nos. 5,412,087, 6,147,205, 6,262,216, 6,310,189, 5,889,165, and 5,959,098. Nucleic acid probe arrays are described in many of the above patents, but the same techniques are applied to polypeptide probe arrays.

Nucleic acid arrays that are useful in the invention include, but are not limited to, those that are commercially available from Affymetrix (Santa Clara, Calif.) sold under the trademark GENECHIP®. Example arrays are shown on the website at affymetrix.com.

Probe arrays have many uses including, but are not limited to, gene expression monitoring, profiling, library screening, genotyping and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. patent application Ser. No. 10/442,021 (abandoned) and U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

Samples can be processed by various methods before analysis. Prior to, or concurrent with, analysis a nucleic acid sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the probe array. (See, for example, U.S. Pat. No. 6,300,070 and U.S. patent application Ser. No. 09/513,300 (abandoned), all of which are incorporated herein by reference).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/10315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference.

Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225, and in U.S. patent application Ser. No. 09/916,135 (abandoned).

Hybridization assay procedures and conditions vary depending on the application and are selected in accordance with known general binding methods, including those referred to in Maniatis et al., Molecular Cloning: A Laboratory Manual, 2^{nd} Ed., Cold Spring Harbor, N.Y., (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623 each of which are incorporated herein by reference.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than about 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations or conditions of 100 mM MES, 1 M [Na+], 20 mM EDTA, 0.01% Tween-20 and a temperature of 30-50° C., or at about 45-50° C. Hybridizations may be performed in the presence of agents such as herring sperm DNA at about 0.1 mg/ml, acetylated BSA at about 0.5 mg/ml. As other factors may affect the stringency of hybridization, including base composition and length of the complementary strands, presence of organic solvents and extent of base mismatching, the combination of parameters is more important than the absolute measure of any one alone. Hybridization conditions suitable for microarrays are described in the Gene Expression Technical Manual, 2004 and the GeneChip® Mapping Assay Manual, 2004.

Hybridization signals can be detected by conventional methods, such as described by, e.g., U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, U.S. patent application Ser. No. 10/389,194 (U.S. Patent Application Publication No. 2004/0012676, allowed on Nov. 9, 2009) and PCT Application PCT/US99/06097 (published as WO 99/47964), each of which is hereby incorporated by reference in its entirety for all purposes).

The practice of the invention may also employ conventional biology methods, software and systems. Computer software products of the invention typically include, for instance, computer readable medium having computer-executable instructions for performing the logic steps of the method of the invention. Suitable computer readable medium include, for example a floppy disk, CD-ROM/DVD/DVD-ROM, hard-disk drive, flash memory, ROM/RAM, and magnetic tapes. The computer executable instructions may be written in a suitable computer language or combination of several computer languages. Basic computational biology methods which may be employed in the invention are described in, for example, Setubal and Meidanis et al., Introduction to Computational Biology Methods, PWS Publishing Company, Boston, (1997); Salzberg, Searles, Kasif, (Ed.), Computational Methods in Molecular Biology, Elsevier, Amsterdam, (1998); Rashidi and Buehler, Bioinformatics Basics: Application in Biological Science and Medicine, CRC Press, London, (2000); and Ouelette and Bzevanis Bioinformatics: A Practical Guide for Analysis of Gene and Proteins, Wiley & Sons, Inc., 2^{nd} ed., (2001). (See also, U.S. Pat. No. 6,420,108).

The invention can use of various computer program products and software for a variety of purposes, such as probe design, management of data, analysis, and instrument operation. (See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170).

Genetic information obtained from analysis of sensors can be transferred over networks such as the internet, as disclosed in, for instance, (U.S. Patent Application Publication No. 20030097222), U.S. Patent Application Publication No. 20020183936, abandoned), U.S. Patent Application Publication No. 20030100995, U.S. Patent Application Publication No. 20030120432, 10/328,818 U.S. Patent Application Publication No. 20040002818, U.S. Patent Application Publication No. 20040126840, abandoned), 10/423,403 (U.S. Patent Application Publication No. 20040049354.

U.S. patent application Ser. Nos. 11/243,621, filed Oct. 4, 2005, 10/456,370, filed on Jun. 6, 2003 (now abandoned), and 61/267,738, filed on Dec. 8, 2009 describe different aspects of constructing sensor plates, sensor strip plates, processing plates or high-throughput (HT) plates, which may be useful in conjunction with the invention. Each of these applications is hereby incorporated by reference herein in their entirety for all purposes.

### I. DEFINITIONS

The application refers to arrays of probes and arrays of sensors. A probe array is a plurality of probes attached to a surface of a substrate. Usually each different type of probe occupies a different area of the support and it is known or determinable, which of the different probes occupy different areas. There are usually multiple copies of the same probe within any one of the different areas. Probe arrays can be prepared by in situ synthesis on the substrate or by spotting of probes. Probe arrays can also be formed by distributing microparticles bearing probes to discrete locations (e.g., indendations) of a support. A microarray is a small array (e.g., no more than 5, 2 or 1 cm²) often characterized by a large number (e.g., at least 10², 10³, 10⁴′ 10⁵ or 10⁶) of probes and/or high density of different probes (e.g., 10²-10⁷ per cm²). The types of molecules in the probe array can be identical or different from each other. The probe array can assume a variety of formats, including, but not limited to, libraries of soluble molecules, and libraries of compounds tethered to resin beads, silica chips, or other solid supports. A probe array may include polymers of a given length having all possible monomer sequences made up of a specific set of monomers, or a specific subset of such a probe array. In other cases a probe array may be formed from inorganic materials (see Schultz et al., PCT application WO 96/11878).

The term “array of sensors” refers to a systematic arrangement of sensors amenable to simultaneous analysis, usually in rows and columns. The sensors can be probe arrays, such as microarrays, or any types of sensor or probes described herein. An exemplary sensor array is a 12 sensor by 8 sensor array of microarrays, optionally with the individually microarrays being spaced as for the wells on a 96-well microtiter plate. An array of sensors may include any number of sensors, and if the sensors are probe arrays, the probe arrays can include any number of probes.

The term “detection plate” or “detection tray” as used herein refers to a body having at least two wells and at least one optically transparent window. A detection plate is a device used during the identification of the hybridization events on a plurality of sensors, such as from a sensor plate. Taking a sensor plate as an example, the corresponding detection plate is designed to receive the sensor plate. In one embodiment, the wells are filled with a solution such that the sensors from the sensor plate are submerged when the sensor plate and the detection plates are assembled. The scanning of the sensors is performed through the optically transparent window which can be made from a low-fluorescence material such as fused silica, or Zeonor (Nionex). Optionally, a detection plate can have a physical barrier resistant to the passage of liquids around the individual wells or around a plurality of wells.

The term “monomer” as used herein refers to any member of the set of molecules that can be joined together to form an oligomer or polymer. The set of monomers useful in the invention includes nucleotides and nucleosides for nucleic acid synthesis and the set of L-amino acids, D-amino acids, or synthetic amino acids for polypeptide synthesis. Different basis sets of monomers may be used at successive steps in the synthesis of a polymer.

The term “nucleic acid” as used herein refers to a polymeric form of nucleotides of any length, either ribonucleotides, deoxyribonucleotides or peptide nucleic acids (PNAs) or (Locked nucleic acids, LNAs), that include purine and pyrimidine bases, or other natural, chemically or biochemically modified, non-natural, or derivatized nucleotide bases. Nucleic acids can be single or double stranded. The backbone of the nucleic acid can include sugars and phosphate groups, as may typically be found in RNA or DNA, or modified or substituted sugar or phosphate groups. A nucleic acid may include modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids can be isolated from natural sources, recombinantly produced or artificially synthesized and mimetics thereof, such as LNA, “Locked nucleic acid”. A further example of a nucleic acid is a peptide nucleic acid (PNA). Double stranded nucleic acid usually pair by Watson-Crick pairing but can also pair by Hoogsteen base pairing which has been identified in certain tRNA molecules and postulated to exist in a triple helix. The term “oligonucleotide” refers to a nucleic acid of about 7-100 bases, (e.g., 10-50 or 15-25).

A probe has specific affinity for a target (or analyte) in a sample. For nucleic acid probes and nucleic acid targets, specific affinity is primarily determined by ability to form Watson Crick complementary base pairs on hybridization. For example, an oligonucleotide probe can be designed to be perfectly complementary to its intended target. Targets may be naturally-occurring or man-made molecules. Also, they can be employed in their unaltered state or as aggregates with other species. Targets may be attached, covalently or noncovalently, to a binding member, either directly or via a specific binding substance. Examples of targets include antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. U.S. Pat. No. 6,582,908 provides an example of probe arrays having all possible combinations of nucleic acid-based probes having a length of 10 bases, and 12 bases or more. Nucleic acid probes can be, for example, olignucleotides or cDNAs. Probes can be linear. A probe may also consist of an open circle molecule, comprising a nucleic acid having left and right arms whose sequences are complementary to the target, and separated by a linker region (see, e.g., U.S. Pat. No. 6,858,412, and Hardenbol et al., Nat. Biotechnol., 21(6):673 (2003)). A probe, such as a nucleic acid can be attached directly to a support (optionally derivatized with a linker). A probe can also be attached or associated to a microparticle, and the microparticle attached to the support, for example, in an indentation or divot in the support. Examples of encoded microparticles, methods of making the same, methods for fabricating the microparticles, methods and systems for detecting microparticles, and the methods and systems for using microparticles are described in U.S. Patent Application Publication Nos. 20080038559, 20070148599, and PCT Application No. WO 2007/081410 (all incorporated by reference). Such microparticles are preferably encoded such that the identity of a probe borne by a microparticle can be read from a distinguishable code. The code can be in the form of a tag, which may itself be a probe, such as an oligonucleotide, a detectable label, such as a fluorophore, or embedded in the microparticle, for example, as a bar code. Microparticles bearing different probes have different codes. Microparticles are typically distributed on a support by a sorting process in which a collection of microparticles are placed on the support and the microparticles distributed on the support. The location of the microparticles after distribution on the support can be defined by indentations such as wells or by association to adhesive regions on the support, among other methods. The microparticles may be touching or they may be separated so that individual microparticles are not touching.

The term “sensor” as used herein refers to any device that detects or analyzes an analyte or target in a sample. The sensor includes a recognition element or probe, e.g. enzyme, receptor, molecule, nucleic acid, antibody, or microorganism typically attached to a substrate. A sensor may be associated with an electrochemical, optical, thermal, or acoustic signal transducer that on binding of the probes permits analysis and or detection of chemical properties or quantities of an analyte, or can in combination with a target, result in a signal, detectable by a separate reader. A sensor can be a probe array, such as a microarray with any number of probes attached to a support.

The term “sensor plate” as used herein refers to a plate having one or more sensors, although typically the sensor plate includes a plurality of sensors. The sensor plate can be referred to by a name based on the type of sensor. For example, if the sensors on a sensor plate are microarrays, then the plate can be referred to as a microarray plate, DNA plate, or an oligonucleotide plate.

The term “shipping plate” as used herein refers to a device with at least two wells suitable for protecting at least two sensors. The shipping plate is a device used during the handling and shipping of the sensors, such as on a sensor plate. The shipping plate is designed to receive the sensor plate. Once the sensor plate is assembled and inspected, the shipping plate is assembled, contacted, or connected with the sensor plate. Optionally, the shipping plate can have a physical barrier resistant to the passage of liquids and gases around the individual wells or around a plurality of wells. Optionally, the shipping plate may include features to allow multiple sensor plates to be stacked on top of each other.

The terms substrate refers to a material or group of materials having a rigid, semi-rigid surface or flexible surface suitable for attaching an array of probes. In one embodiment, the surface may be a combination of materials where at least one layer is flexible. Surfaces on the solid substrate can be of the same material as the substrate. In another embodiment, the substrate may be fabricated form a single material or be fabricated of two or more materials. Thus, the surface may be composed of any of a wide variety of materials, for example, polymers, plastics, resins, polysaccharides, silica or silica-based materials, carbon, metals, inorganic glasses, membranes, or any of the above-listed substrate materials. In a further embodiment, the surface can be supported by a flexible material or a solid material. In many embodiments, at least one surface of the substrate is flat, although in some embodiments it may be desirable to physically separate synthesis regions for different compounds with, for example, wells, raised regions, pins, etched trenches, or the like. According to other embodiments, the substrate takes the form of beads, resins, gels, microspheres, or other geometric configurations. (See, U.S. Pat. No. 5,744,305 for exemplary substrate, which is hereby incorporated by reference herein in its entirety for all purpose).

The term “stain plate” as used herein refers to a device with at least two wells suitable for staining of a sensor plate. In one embodiment, the well depth is optimized to use the minimum volume of sample that is desired. The stain plate is a device used during an assay of the sensor, in particular the staining step for a plurality of sensors, such as on a sensor plate. Taking the sensor plate as an example, the corresponding stain plate is designed to receive the sensor plate. In one embodiment, after the stain solution is deposited into the wells of the stain plate, the sensor plate is assembled with the stain plate such that the active surfaces of the sensors are submerged into the stain solution. Optionally, the stain plate may include a physical barrier resistant to the passage of liquids and gases around the individual wells or around a plurality of wells.

The term “wafer” as used herein refers to a substrate having a surface to which a plurality of probe arrays (e.g., microarrays) are bound. The substrate can have a flat surface of glass or silica among other materials. Surfaces on the solid substrate can be formed from the same material as the substrate or a different material. Thus, the surface can be any of a wide variety of materials, for example, polymers, plastics, resins, polysaccharides, silica or silica-based materials, carbon, metals, inorganic glasses, membranes, or any of the above-listed substrate materials which may also be present in combinations or layers. In one embodiment, the surface may be optically transparent and may have surface silicon hydroxide functionalities, such as those found on silica surfaces.

The term “wash plate” as used herein refers to a device with at least two wells suitable for washing a sensor. The well depth and design can be optimized to efficiently wash the sensor with an optimal volume. The wash plate is a device used during an assay of the sensors, in particular the washing step for a plurality of sensors, such as on a sensor plate. Taking the sensor plate as an example, the corresponding wash plate is designed to receive the sensor plate. In one embodiment, after the washing solution is deposited into the wells of the wash plate, the sensor plate is assembled. The active surfaces of the sensors are submerged into the washing solution. Optionally, the wash plate may have a physical barrier resistant to the passage of liquids and gases around the individual wells or around a plurality of wells.

### II. SPECIFIC EMBODIMENTS

The invention provides methods and components for assembly of arrays of sensors from modular units (e.g., modules) containing component sensors of the array. The assembled arrays of sensors are sometimes referred to as modular arrays, modular sensor array plates, or sensor plates. The modules of sensors can readily be assembled in different combinations thereby allowing many different modular arrays to be assembled from the same building blocks. Such modular arrays assemblies offer advantages of economies of scale for a manufacturer of the modular units and flexibility for an end user by allowing the end user to customize arrays according to the user's individual needs from a relatively small number of modules provided by the manufacturer.

The modular arrays are particular useful for sensors that are probe arrays, for example, a microarray of nucleic acid probes, such as the GENECHIP® array. Such probe arrays have a variety of applications in analyzing samples, for example, in expression monitoring, detecting mutations, or detecting presence of analyte. In some experiments, a user may wish to use multiple copies of the same microarray to perform parallel analyses on multiple samples, In other analyses, a user may wish to use different microarrays to perform different analyses. In still other arrays, a user may wish to use combine different microarrays and multiple copies of one or more of the different microarrays for simultaneous analyses. The methods allow microarrays to be assembled in any of these permutations, effectively forming an array of microarrays, each of which can be processed and analyzed simultaneously.

The modules for assembly of arrays have one or more sensors fixed to a support. Thus, for example, when the sensors are microarrays, a sensor module unit has one or more microarrays attached to its surface. Multiple copies of the same microarray can be synthesized in parallel on the same substrate, referred to as a wafer. Different types of array can be synthesized on different wafers. The wafers can be diced up, e.g. sawed, into individual arrays of the same type and the individual arrays then attached to the support components of modules. If one or more microarrays are attached to the surface of the same module, the arrays can be the same or different. The arrays present on one module can be selected independently of the arrays present on any other module. In one embodiment, each module has multiple copies (e.g., eight copies) of the same type of array, and different modules have different types of array. Arrays can be transferred intact to a support as when a wafer is diced and individual arrays are then attached to a support. Alternatively, arrays can be formed on the support, as for example, by distribution of microparticles bearing different probes to different locations (e.g. indendations) of a support surface.

The modules are designed to include a means for attaching the units into a fixed position in a frame that accommodates multiple modular units. When multiple modules are fixed in the frame, the sensors (e.g., microarrays) on the multiple modules align in substantially the same plane forming an array of sensors (e.g., an array of microarrays) amenable to simultaneous analysis. A user can determine which permutation of modular units is incorporated into the frame, and thus, which sensors are incorporated in the array of sensors. Preferably, the frame aligns the fixed modules such that the array of sensors formed from the sensors on component modules is a regular array with parallel rows and columns of sensors. For example, the individually spacers in such an array can be spaced so as to align with the wells on a standard 96 well microtiter plate.

Once formed, the array of sensors can be processed in similar fashion to conventional multi-array plates. Processing steps typically include contacting individual sensors with individual samples, hybridization, washing, staining and scanning. Some or all of these steps can be performed in a largely or completely automated fashion using equipment such as the GENETITAN® or GENEATLAS® instruments.

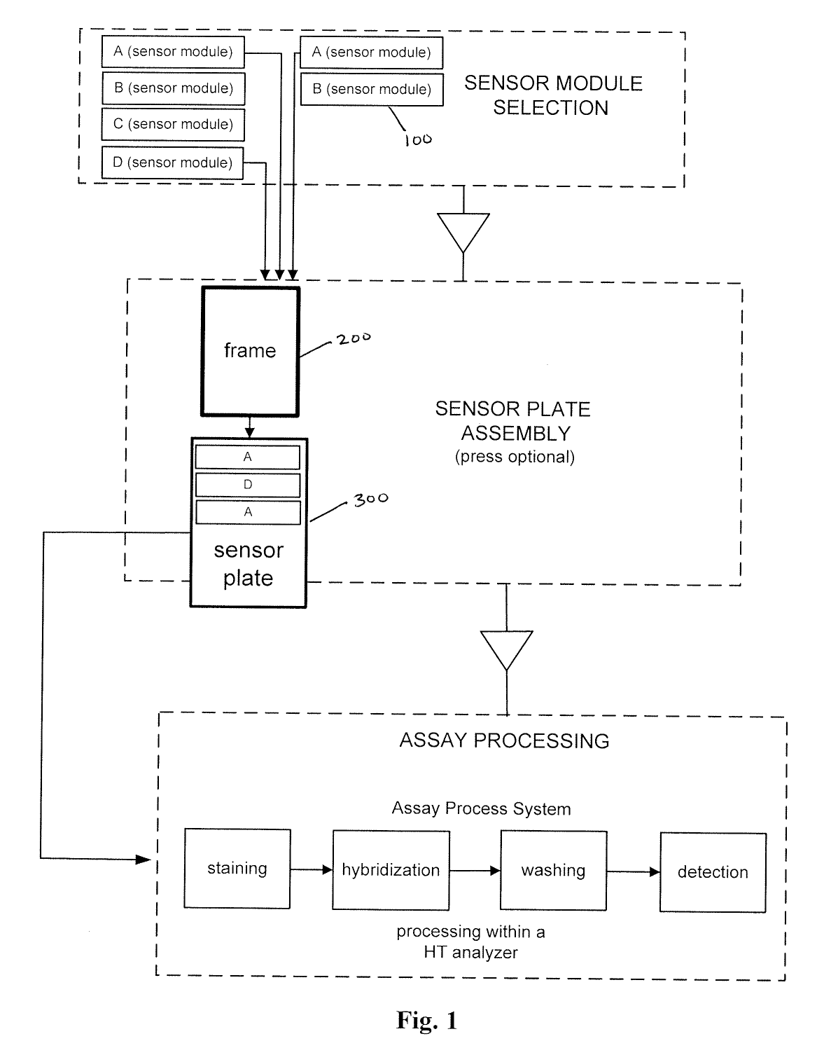

FIG. 1 schematically illustrates an exemplary sensor array plate 300 assembled from individual sensor modules 100 and a frame 200 for use in an assay process. Sensor modules 100 are selected from various differing sensor modules 100, shown in FIG. 1 as Types A, B, C and D, for example. Types A, B, C and D correspond to any differing types of sensors utilized in assay processing. Generally, a user will select sensor modules 100 having a compatible assay protocol. The user will fixedly attach the sensor modules 100 to a frame 200 forming modular sensor array plate 300. The sensor plate 300 may then be used in an assay process, preferably with HT analysis equipment performing simultaneous analysis of the sensors of sensor plate 300.

As shown in the first step of FIG. 1, a user may select individual sensor modules 100 according to the user's needs. For instance an LT user may have only enough samples to utilize three sensor modules, and may require only sensors of Type A and Type D, for example. The user may then select two Type A sensor modules and one Type D sensor module. Pre-fabricated sensor plates composed entirely of either eight Type A sensor modules or eight Type D modules would likely require the user to run two separate assays on two separate plates, utilizing less than half the sensors on each plate. The customizable sensor plate as shown in FIG. 1 allows the user to select only the sensor modules 100 needed, thereby increasing the cost-effectiveness and efficiency of the assay process, particularly for an LT end user.

As shown in the second step of FIG. 1, the user assembles a modular sensor array plate 300 from the individually selected sensor modules 100 and a frame 200. The user may optionally use an assembly press, especially suited for assembling the modular sensor array plate 300. The sensor modules 100 attach to the frame 200 with a coupling surface or surfaces that interface with a corresponding coupling surface of the frame 200. The sensor module 100 coupling surface may include snaps, pegs, undercuts that nest within the frame, retaining members, adhesive layers, and UV curable adhesives. The sensor modules 100 also includes an alignment feature that interface with a corresponding alignment feature of the frame 200 to ensure the sensors form an array of sensor suitable for processing with HT analysis equipment. The alignment features may include protrusions, ridges, notches, recesses, pins and pegs. Once the sensor modules 100 are attached and aligned with the frame 200, the resulting assembly, also known as the sensor array plate 300, can be used for performing an assay procedure.

As shown in the third step of FIG. 1, the user may utilize the modular sensor array plate 300 in an assay process. Typically, the assay process includes a staining, hybridization, washing and detection steps. The steps of the assay process generally include the use of processing trays that allow for simultaneous analysis of each sensor of the sensor plate 300.

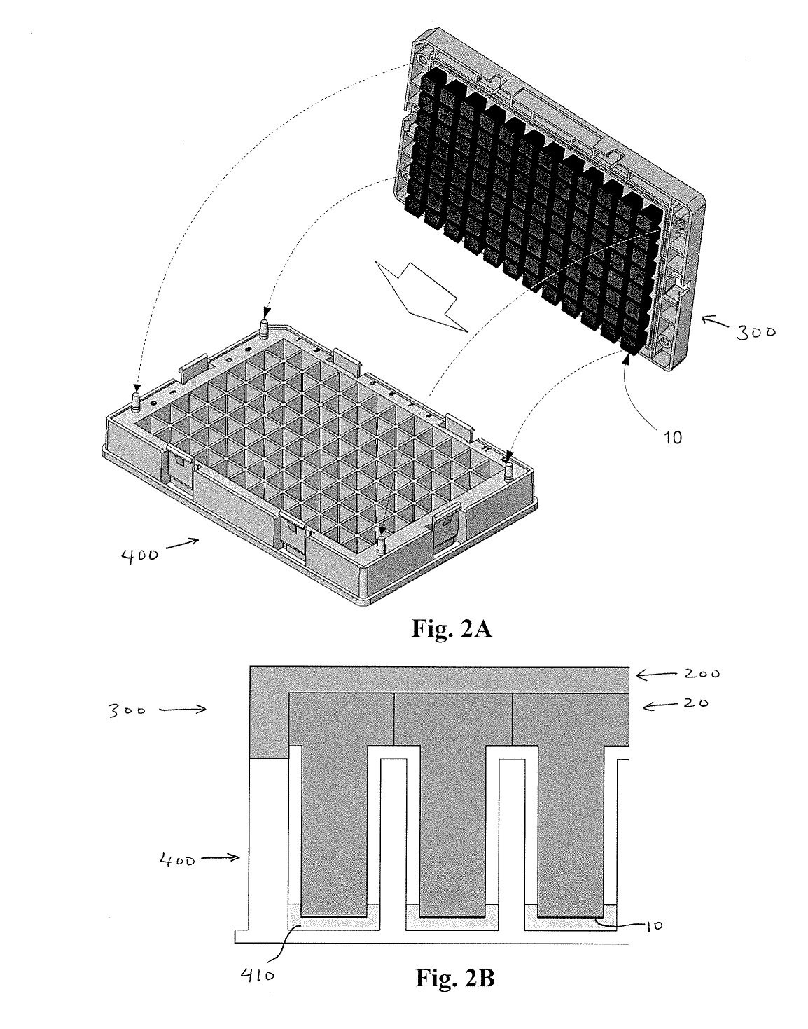

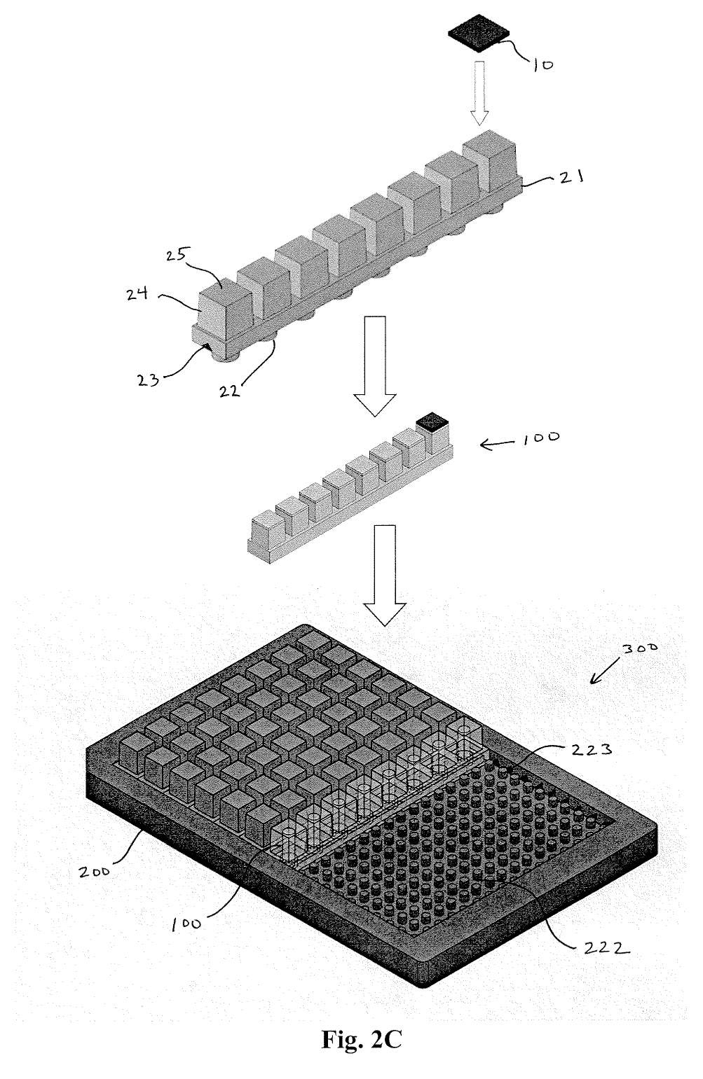

According to one aspect of the invention, the sensor plate 300 attaches or interfaces with a processing plate 400, as illustrated in FIG. 2A. Typically, a processing tray 400 includes a plurality of wells, each well corresponding to a sensor 10 of the sensor plate 300. In many embodiments, each sensor 10 of the sensor plate 300 protrudes outward from a side of the sensor plate 300 on a square peg-like protrusion. In an exemplary embodiment, the processing tray 400 is a rectangular hybridization tray made up of a 12 by 8 matrix of square wells that are open to a receiving side of the hybridization tray. Each square well is dimensioned so that the well receives a sensor of the sensor plate. The hybridization tray may be a standard off-the-shelf model or may be a customized tray. In some embodiments, the tray has four pins, one at each corner of the receiving side that fit into corresponding holes on each corner of a rectangular sensor plate 300 of similar size. The pins act to attach and align the sensor plate 300 to hybridization tray 400 to ensure each sensor 10 is placed within a well of the hybridization tray 400. The tray or sensor plate 300 may also include a gasket that fits around the edges of the tray or plate so as to contain fluid between the plates or between each wells during processing and prevent contamination of the sensors between wells.

As illustrated in FIG. 2B, the wells of the processing tray 400 receive the peg-like protrusions of the sensor plate 300 so as to expose each sensor 10 to a processing fluid 410 at the bottom of each well. The wells are dimensioned so as to use a minimal amount of fluid 410 in each well, while still exposing each sensor the fluid 410 during an assay process, for instance during the staining, hybridization or detection processes. The wells of the processing tray 400 may range from a depth of 1 mm to 50 mm, for example a depth of 2.54 cm. Placement of the sensor plate 300 on receiving side of the processing plate 400 so as to simultaneously expose each sensor 10 to processing fluid 410 is useful in the assay process of an HT analyzer, for example the staining, hybridization, washing, or detection process.

An exemplary embodiment of the invention is illustrated in FIG. 2C. In one aspect of the invention, a user may attach a sensor strip module 100 to a frame 200 producing a sensor plate assembly 300. The sensor plate 300 may include one or more sensor modules 100 for use in an HT analyzer. Each sensor module 100 includes a solid support 20 and at least one sensor 10, but often includes a plurality of sensors, for example 8 sensors. The plurality of sensors 10 on a particular sensor module 100 may be of the same type or different types. In one aspect of the invention, the modules 100 may be analyzed separately, as in an LT analyzer that processes individual modules, such as the GENEATLAS® instrument. In another aspect, the sensor modules 100 may be placed within frame 200 to form a sensor plate 300 for use with a HT analyzer, such as the GENETITAN® instrument. It is noted that the sensor modules 100 are not limited for use with the GENEATLAS® or GENETITAN® instruments and may be used with any assay process.

Sensor Array Plate. In the exemplary embodiment, the sensor array plates 300 allow a plurality of sensors 10 to be processed simultaneously in an assay process of an HT analyzer, such as the GeneTitan™ instrument. The dimensions of sensor plate 300 may vary depending on the size and number of the sensors 10, and the processing methods and apparatus.

In an exemplary embodiment, illustrated in FIG. 2A, the sensor plate 300 includes a rectangular frame having 12 sensor modules 100, each sensor module 10 having a row of 8 evenly spaced sensors disposed on 8 square planar peg-like protrusions. The sensors 10 of the sensor plate 300 forms an 8×12 array of sensors 10 that can be simultaneously processed in an HT analyzer, for example the GeneTitan™ instrument. The positioning of the sensors 10 within the sensor plate 300 also allows for use with various standard processing trays 400, as discussed above, and various assay processes.

In one aspect of the invention, the sensor plate 300 is assembled from a frame 200 and one or more sensor modules 100, each sensor module 100 having at least one sensor 10. The frame 200 receives each sensor module 100 in a position that is fixed and aligned according to a pre-determined alignment. The pre-determined alignment of the sensors may vary according to the analyzer used to process the sensor plate 300. For example, processing a sensor plate 300 in the GeneTitan™ instrument may require a rectangular array of sensors 10, wherein adjacent sensors 10 of the array are separated by approximately 9 mm along the direction of the length and width of the array. The pre-determined alignment and spacing requirements may vary in different HT analyzers. The modules 100 are also fixed to the frame 200. In many embodiments, the fixed position constrains the movement of the modules 100 in each direction so as to allow full rotational movement of the frame in each direction without dislodging or altering the alignment of the sensor modules 100 relative to the frame 200. Having the modules 100 fixed in a pre-determined alignment relative to the frame allows the sensor modules 300 to be handled, shipped, and processed without altering the position of the sensors 10 relative to the frame 200. This aspect of the invention also facilitates assay processing, which typically requires turning the sensor plate 300 upside down to insert the sensors 10 face into the wells of processing tray 400.

A sensor plate 300 assembled from a frame 200 and sensor modules 100 offers a number of advantages over prior sensor plates. Generally, current pre-fabricated HT sensor plates include a large number of identical sensors, which greatly limits a user's option. A low-throughput user having only a few samples, for example, may not be able to fully utilize such a pre-fabricated HT sensor plate. A LT user may choose to wait until accumulating enough samples to fully utilize a pre-fabricated HT sensor plate. This option may result in increased turn-around-times for delivering assay detection results. Other LT users may choose to perform an assay of only a few samples on a pre-fabricated HT sensor plate, effectively wasting unused sensors. Given the relatively high cost of sensor plates, this option may significantly increase the costs associated with performing assays for an LT user. Additionally, a user requiring different types of assays for one sample may have to run multiple assays using multiple sensor plates, since pre-fabricated HT sensor plates have only generally have one type of sensor. Since the claimed sensor modules allow for more flexibility in assembling a sensor plate, the invention offers the user more options in performing an assay.

In one aspect of the invention, a user may assemble a sensor plate from any number of modules 100 that fit within the frame to produce a customized HT sensor plate 300, for example, a user requiring an assay of only a few samples may assemble a sensor plate with only one module and can still process the samples in an HT analyzer. In another aspect, a user may assemble a customized HT sensor plate 300 having different types of modules 100 and process all the samples simultaneously in an HT analyzer so long as the modules share a compatible assay protocol. The customize HT sensor plates are advantageous as it offers the user more options in utilizing an HT analyzer and may reduce turn-around-times and increase efficiency in assay processing. Although the invention contemplates allowing a user to assembly and customize a sensor plate, a manufacturer or third party may assemble a customized sensor plate 300 with the described sensor modules 100.

Sensor Plate comprising a plurality of Sensor Modules. In an embodiment, a sensor plate 300 includes a plurality of sensor modules 100 attached to support frame 200, as shown in FIG. 2C. The sensor modules may be placed separately into the frame or may be placed simultaneously into the frame, such as in an assembly press 700, for example. There are several ways the sensor modules 100 can be attached to the frame 200, including but not limited to various attachment mechanisms, for example, snaps, latches, interlocking features, tongue-and-groove, undercuts, pegs, and adhesives. These attachment mechanisms include a coupling surface 22 and can be any type of method to attach one part to another. For example, a plurality of one type of attachment means or a combination of different types of attachment means can be used to attach the modules 100 to the frame 200. In one aspect of the invention, the attachment means may also include an alignment feature 23 to attach the module 100 to the frame 200 in the pre-determined alignment, as discussed above. Alternately, the alignment feature may be a separate feature or mechanism independent of the attachment means. The frame may be constructed in any shape and may include any number of modules so long as the frame can receive a plurality of sensor modules in a fixed aligned position to form a sensor plate suitable for assay processing. The number of sensor modules 100 in a sensor plate 300 will depend on several factors, such as the requirements of the user, the size and number of the sensor, the size of the module, the size of the support structure, etc. A sensor cover may also be used to protect some sensors of the sensor plate 300 from contamination while other sensors on the sensor plate are being processed.

Sensor Modules. The sensor modules include a sensor 10 and a solid support 20. In many embodiments, the solid support 20 includes a base portion 21 and peg-like protrusions 24 that extend a distance from base portion 21. The sensor module 100 includes a sensor 10 which may be disposed on a flat surface 25 of the peg-like protrusion 24. The protrusion 24 may be dimensioned or shaped to support sensors 10 of varying shapes and sizes, for example, a square microarray chip sensor may be supported by a protrusion having a square cross-section, while a circular sensor may be supported by a protrusion having a circular cross-section. In many embodiments, the solid support 20 is shaped as a rectangular strip having eight square peg-like protrusions 24 extending from one side of the strip, as shown in FIG. 2C. The protrusions may extend from about 1 mm to about 100 mm from the base portion to facilitate placing the sensors 10 within the wells of a processing tray 400 so as to expose the sensors to processing fluid 410 in the bottom of the tray. In certain embodiments, the peg-like protrusions 24 extend within a range of 1 mm to 30 mm, for example approximately 2.54 cm.

In many embodiments, the solid support includes a hard rigid material that can adequately support the sensors 10 in a fixed aligned position. The solid support may include a number of materials, including but not limited to plastics, metals, composites, etc. or a combination of materials. The solid support may be constructed from multiple pieces or, as in one embodiment, a single monolithic piece.

The sensors 10 may be attached to a surface of the solid support 20 by a number of attachment methods, including but not limited to fast fasteners, bonding, various adhesives, ultrasonic welding, and the like. In many embodiments, a plurality of sensors 10 are attached to the solid support 20 in an evenly spaced row, each of the sensors 10 attached to a separate flat surface 25 of a peg-like protrusion 24 extending a distance from a rectangular base portion 21, as shown in FIG. 2C. In one embodiment, the module 100 includes a solid support 20 having a rectangular base portion 21 and a row of eight square peg-like protrusions extending approximately the same distance from one side of the base portion. In this embodiment, the row of sensors 10 are evenly distributed and adjacent sensors 10 are separated by approximately 9 mm to facilitate assay processing in standard processing trays.

The sensor modules 100 include a coupling surface 22 for fixedly attaching the module 100 to the frame 200 in the fixed aligned position. The coupling surface 22 attaches the module by interfacing with a corresponding coupling surface of the frame and/or an adjacent module within the sensor plate 300. The coupling surface may include a variety of attachment means, including but not limited to, for example, snaps, latches, interlocking features, tongue-and-groove, undercuts, pegs, and adhesives. In one embodiment, illustrated in FIG. 2C, the coupling surface 22 includes a snap.

The sensor modules 100 also include an alignment feature 23, either incorporated into the coupling surface 22 or as a separate feature, which aligns the module 100 according to the pre-determined alignment before or as the coupling surface 22 fixedly attaches the module 100 to the frame 200. The alignment feature 23 may include a number of different features, including but not limited to, for example, a snap, a peg, a bump, a notch, a pin and a hole. In the embodiment illustrated in FIG. 2C, the alignment feature 23 includes a v-shaped notch. Similar to the coupling surface 22 described above, the alignment feature 23 aligns the module 100 by interfacing with a corresponding alignment feature of the frame or an adjacent module within the sensor plate 300.

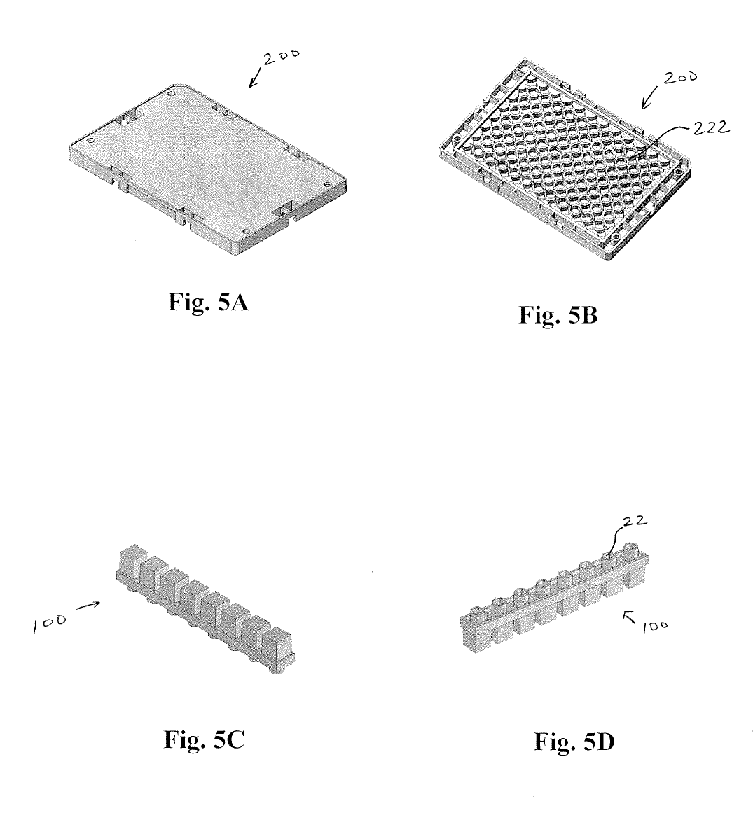

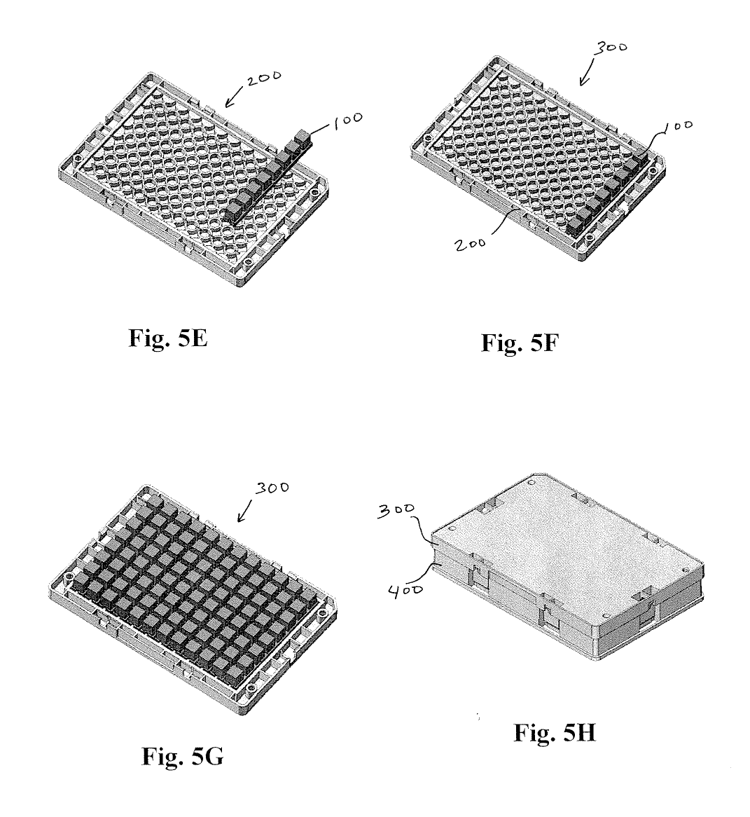

Frame. The frame 200 may be of any shape or size, so long as the frame can receive the sensor modules 100 in a fixed aligned position so as to be processed within an assay protocol. In another embodiment, the frame 200 is constructed such that a sensor plate 300 assembled using frame 200 can be processed within an HT analyzer, such as the GeneTitan™ instrument, for example. In many embodiments, the frame 200 is rectangular in shape and includes four side members, as shown in FIGS. 2C and 5A. The frame 200 includes a coupling surface 222 and an alignment feature 223 that receives a corresponding coupling surface 22 and alignment feature 22 of a sensor module.

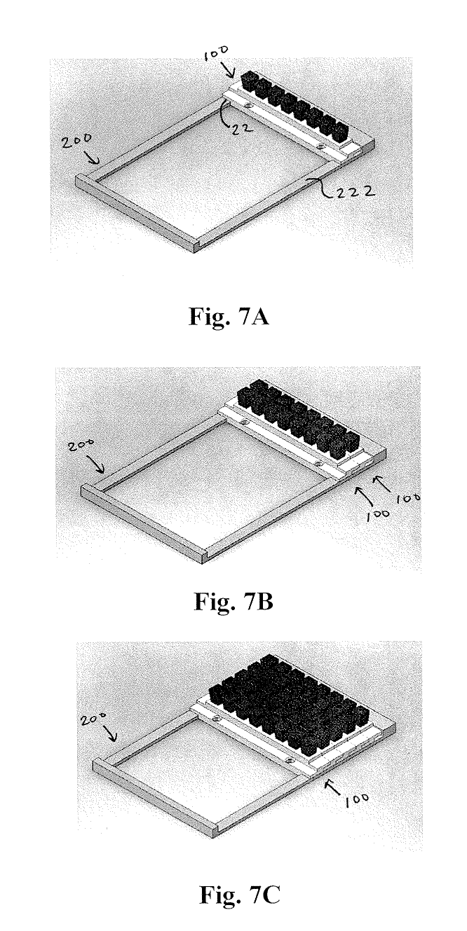

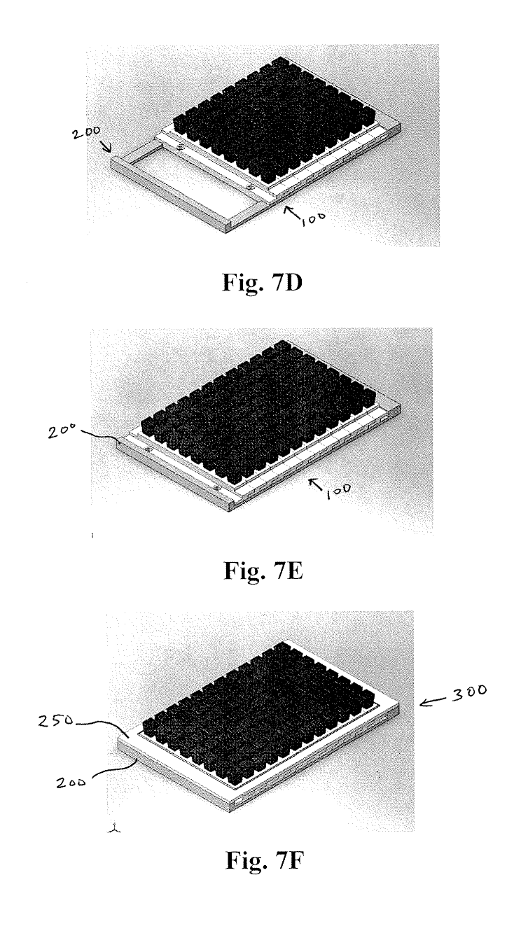

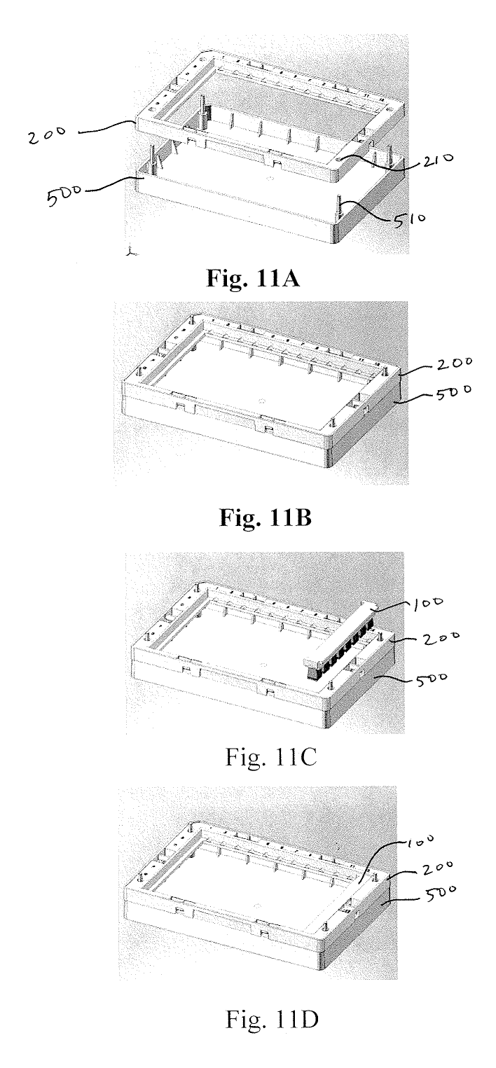

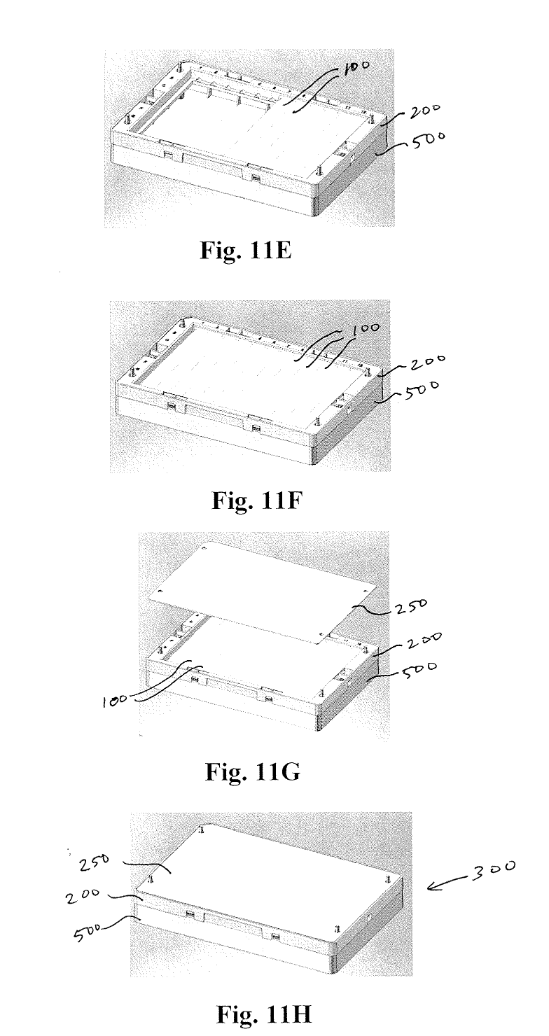

Coupling surface 222 of the frame 200 may include a variety of attachment means, including but not limited, for example, to snaps, latches, interlocking features, tongue-and-groove, undercuts, pegs, and adhesives. In the embodiment of FIGS. 5A and 5B, frame 200 includes a backing having a flat bottom surface and a top surface having a snap coupling surface. In an alternative embodiment, the coupling surface 223 of the frame 200 includes four side members that receive modules 100 having undercuts so as to nest the modules 100 between opposite side members, as shown in FIGS. 7A-7F, for example. The frame 200 may also include an additional retaining member 250 that attaches to the frame 200 to retain or fix the sensor module 100 to the frame. In some embodiments, the retaining member 250 is a rim that fits over the top of the modules 100 nested within a top surface of the frame 200, as shown in FIG. 7F. In another embodiment, the retaining member 250 is flat backing attached to the underside of the frame to constrain modules 100 nested within a bottom surface of frame 200, as shown in FIGS. 11E-11H, for example.

Alignment feature 223 of the frame 200 may include a separate alignment feature or the alignment feature 23 may be incorporated into the coupling surface 222. The alignment feature 23 may include a number of different features, including but not limited to a snap, a peg, a bump, a notch, a pin, adhesive filled wells, or any combination of the features listed here or in any of the described embodiments, for example.

In general, frame 200 is constructed from a material that is compatible with the chemical reactants, the operating environment (including temperature) and solvents that are used in the assay process. Any of a variety of organic or inorganic materials or combinations thereof, may be employed for the frame including but not limited to metals, composites, plastics, such as polypropylene, polystyrene, polyvinyl chloride, poly-carbonate, polysulfone, etc.; nylon; PTFE, ceramic; silicon; (fused) silica, quartz and glass. In circumstances where an assay requires a high hybridization temperature and cold temperature storage, the frame 200 can be made of any material which can withstand high temperatures for hybridization and be stored in cold temperatures for storage (e.g. cyrolite, Hi-Lo acrylic, polycarbonate, etc.).

Frame 200 may be solid, semi-rigid, flexible or a combination thereof and be of any shape, although preferably the frame is rigid so as to support the sensor modules 10 in a fixed aligned position suitable for an assay process. The dimensions of the frame should accommodate the size limitations or requirements of a particular sensor analyzer or assay process. The frame can be formed by machining, molding, mechanical forming, and the like. Preferably, the dimensions of the processing frame are about 5 mm to about 400 mm in length, about 10 mm to about 400 mm in width, and about 0.25 mm to about 25 mm in depth. But these dimensions are only general guidelines and may vary depending on the sensor dimensions, a user's needs or other requirements, etc.

In an alternative embodiment, the frame 200 includes a gasket 240 or an elastomeric seal that acts to seal the processing fluids 410 between the sensor plate 300 and a processing tray 400, for example, to prevent contamination between sensors 10 of a sensor plate 300 during processing. In another embodiment, the frame includes an attachment feature for attaching the frame 200 to a processing tray 400 or cover 500, as shown in FIG. 5H.

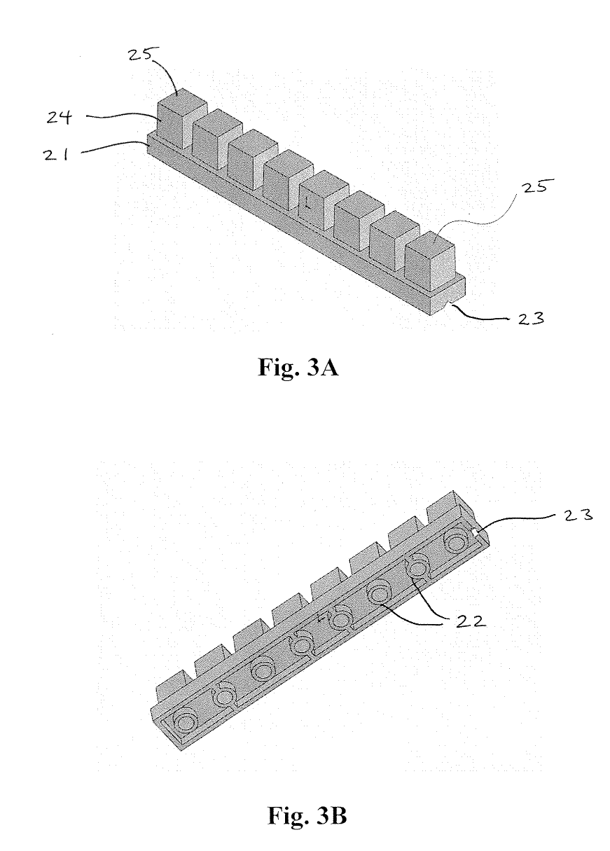

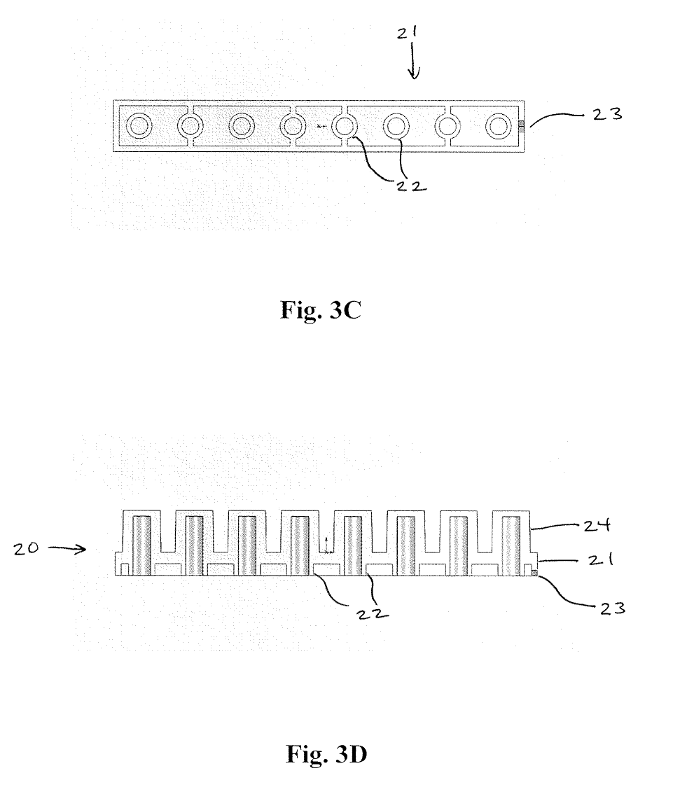

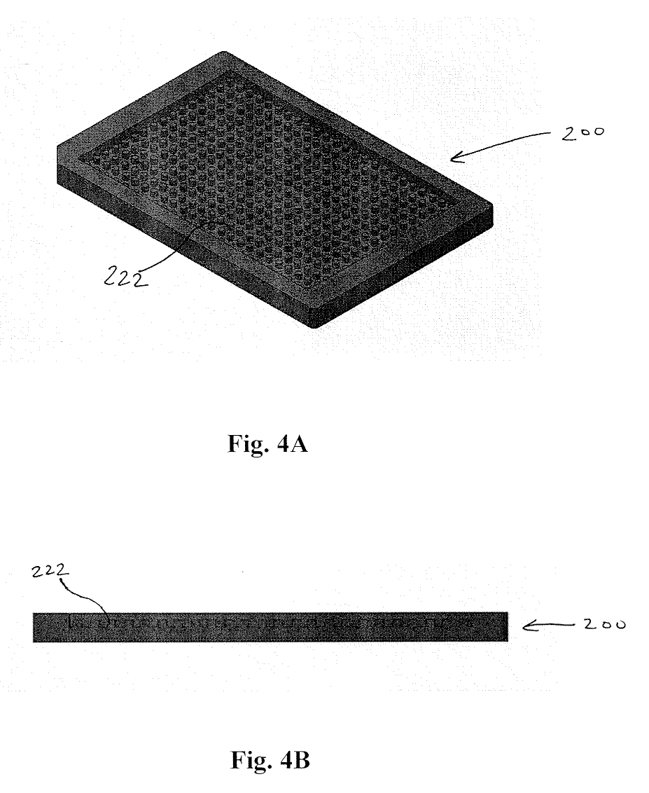

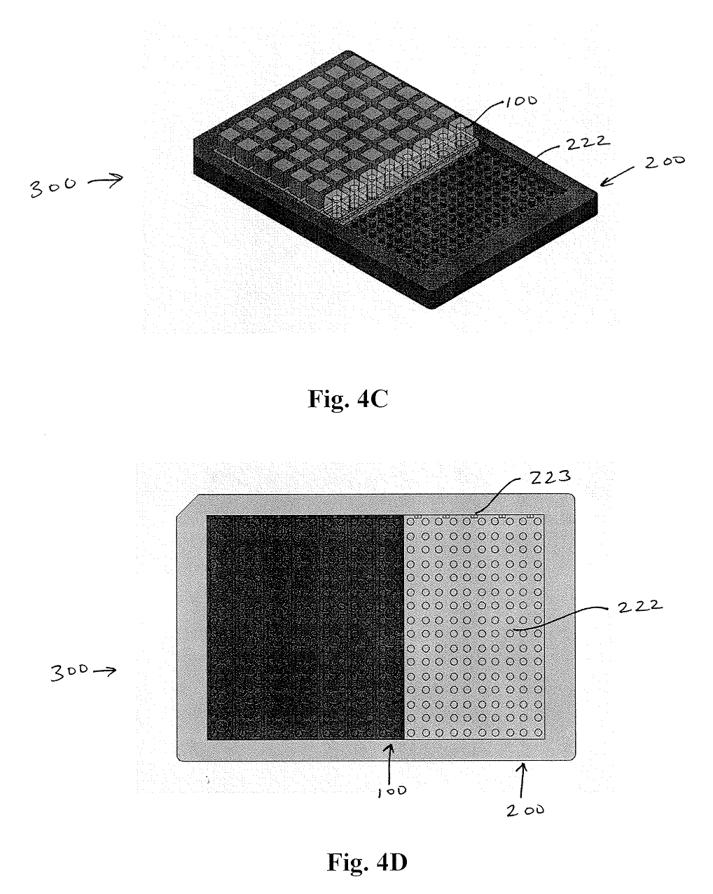

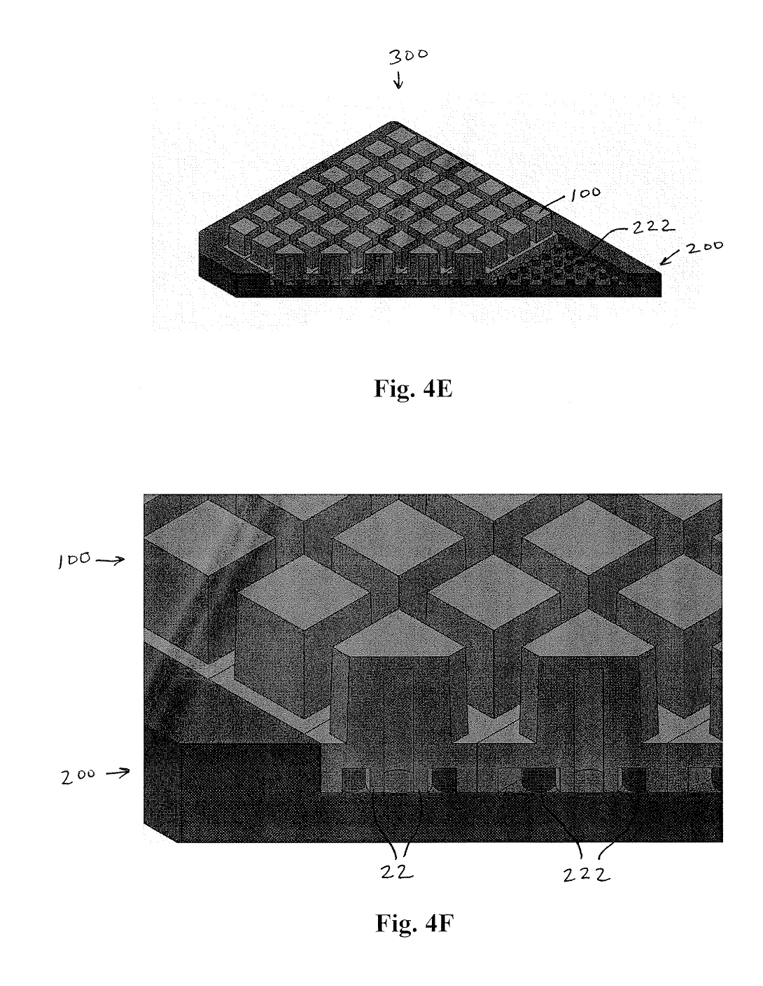

Snap Sensor Modules. In one embodiment of the invention, the coupling surface 22 includes a snap that fits into a corresponding snap coupling surface 222 of the frame. In this embodiment, the snap coupling surface 22 is disposed on the bottom surface of base portion 21, opposite the sensors 100 and protrusions 24. The snap coupling surface 22 of the module 100 is snapped to a corresponding snap coupling surface 222 of the frame 200. In the embodiment of FIG. 3B, the snap coupling surface 22 is a circular snap receivable by a snap coupling surface 222 of the frame. The snap coupling surface 222 of the frame may include a plurality of circular projections, for example, as in FIG. 4A. Snapping the module 100 to the frame 200 includes module 100 includes pressing the snap coupling surface 23 of the module 100 against the snap coupling surface 222 of the frame so as to resiliently displace a snap surface until reaching a snapped position (shown in FIG. 4F), in which a resilient return of the snap surface toward a relaxed configuration holds the module 100 in the desired fixed position. Although FIGS. 4A-4F depict corresponding snap coupling surfaces as being circular, varying sizes and shapes of snap coupling surfaces can be used so long as interfacing coupling surfaces fixedly attach the module 100 to the frame 200. Additionally, the coupling surfaces of the module 100 and the frame 200 are not required to be the same or have similar shapes. For example, the coupling surface 22 of the module 100 may include a circular protrusion that snap fits into a hexagonal hole, which acts as the coupling surface 222 of the frame 200.

In an embodiment of the invention, the coupling surface 22 of the module 100 interfaces with the coupling surface 222 of the frame 200 at a high interference tolerance so that the module 100 is permanently attached to the frame 200 in a fixed position. For example, a coupling surface 22 including a round pin may fit into a coupling surface 222 comprising a hexagonal hole. Alternatively the coupling surface 22 can be a hexagonal hole and the coupling surface 222 a round pin. Interfacing a round pin with a hexagonal hole may provide significant interference tolerance so as to permanently attach the module 100 to the frame 200. In this embodiment, the coupling surface 22 of the module 100 and the coupling surface 222 of the frame may be any number of shapes, not necessarily the same shape. Preferably, the coupling surfaces are of a different shape to maintain high interference tolerances permanently attaching the module 100 to the frame 200.

The snap sensor module 100 also includes an alignment feature 23, which may be a separate feature or may be incorporated into the snap coupling surface 22 such that the snapped position has the proper alignment. In one embodiment, the alignment feature 23 is a v-shaped notch in the bottom of base portion 21 of module 100 that corresponds with a v-shaped bump or ridge alignment feature 223 of the frame. In this embodiment, the module 100 is aligned with the frame 200 by placing the notch alignment feature 23 of the module over the bump alignment feature 223 of the frame. The module 100 is then attached to the frame 200 by pressing the module 100 against the snap coupling surface 222 until the snap coupling feature 22 engages or snaps with the snap coupling surface 222. Once aligned and snapped into place, the module 100 fixed in the aligned position on the frame 200 forming a sensor plate 300 suitable for use with a processing tray 400 in an assay process, as illustrated in FIG. 5H.

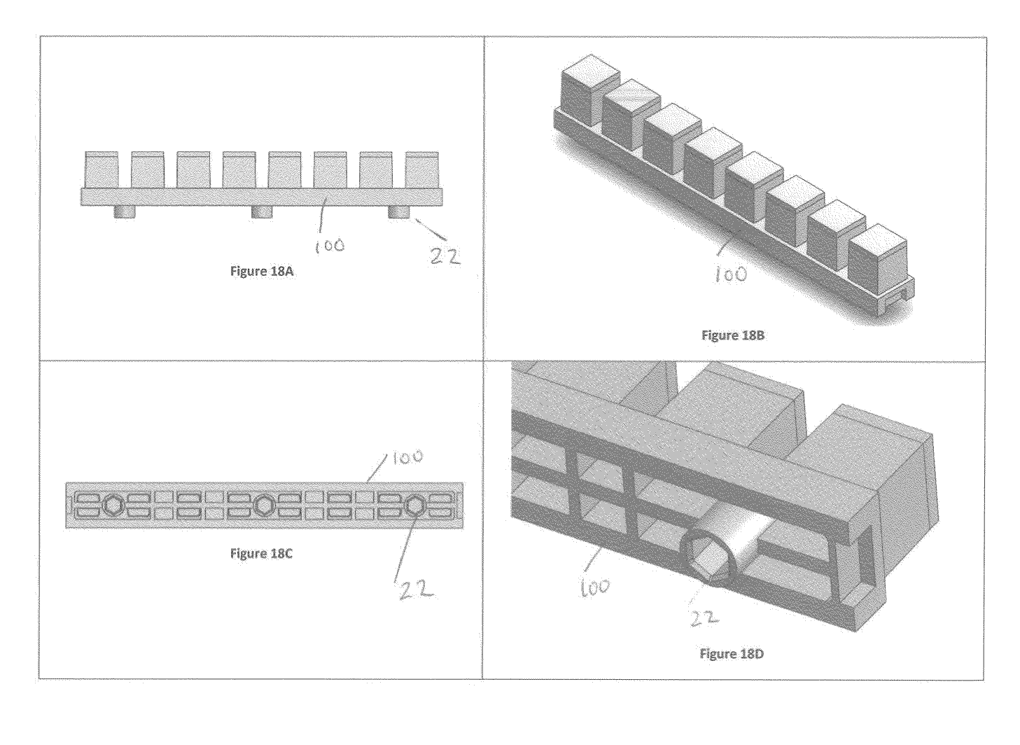

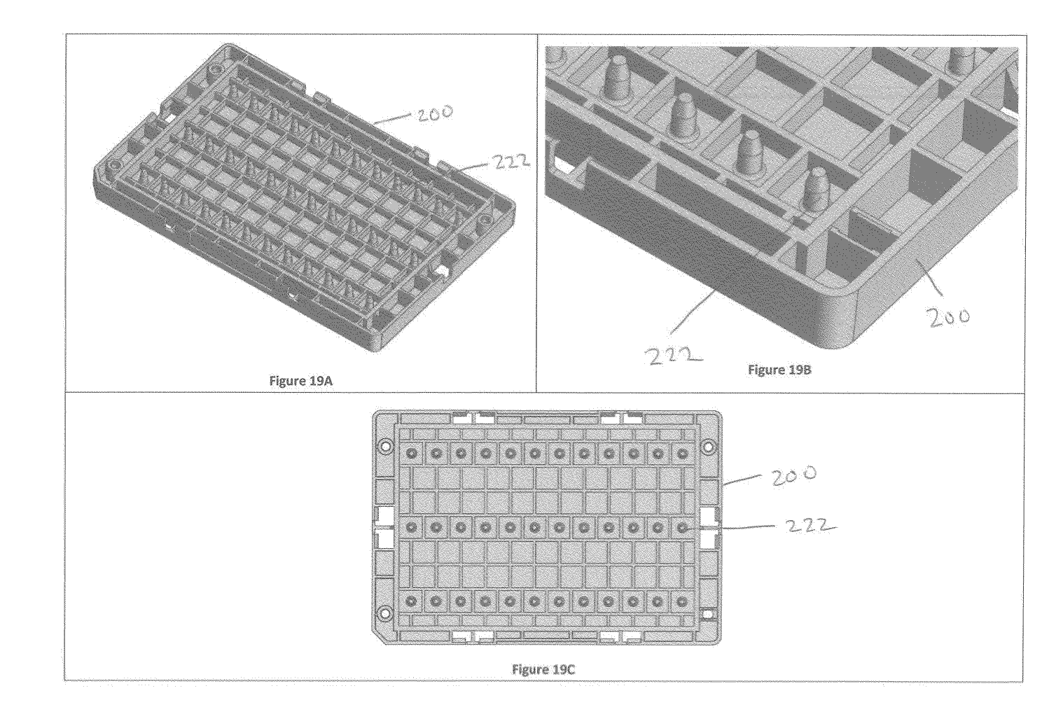

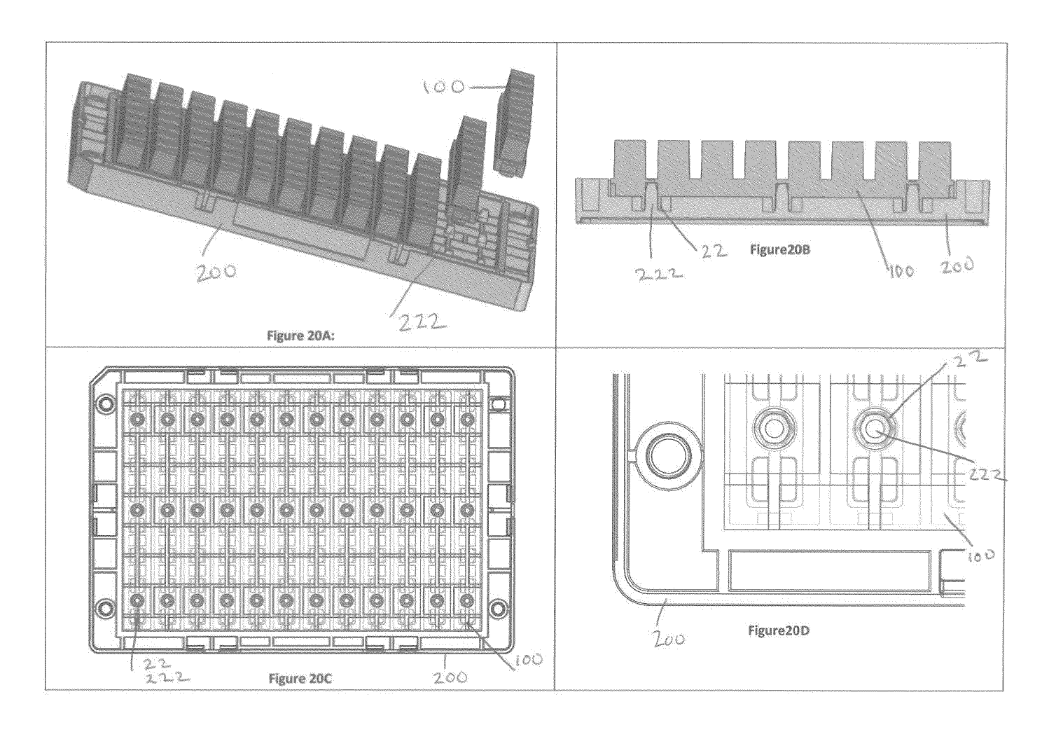

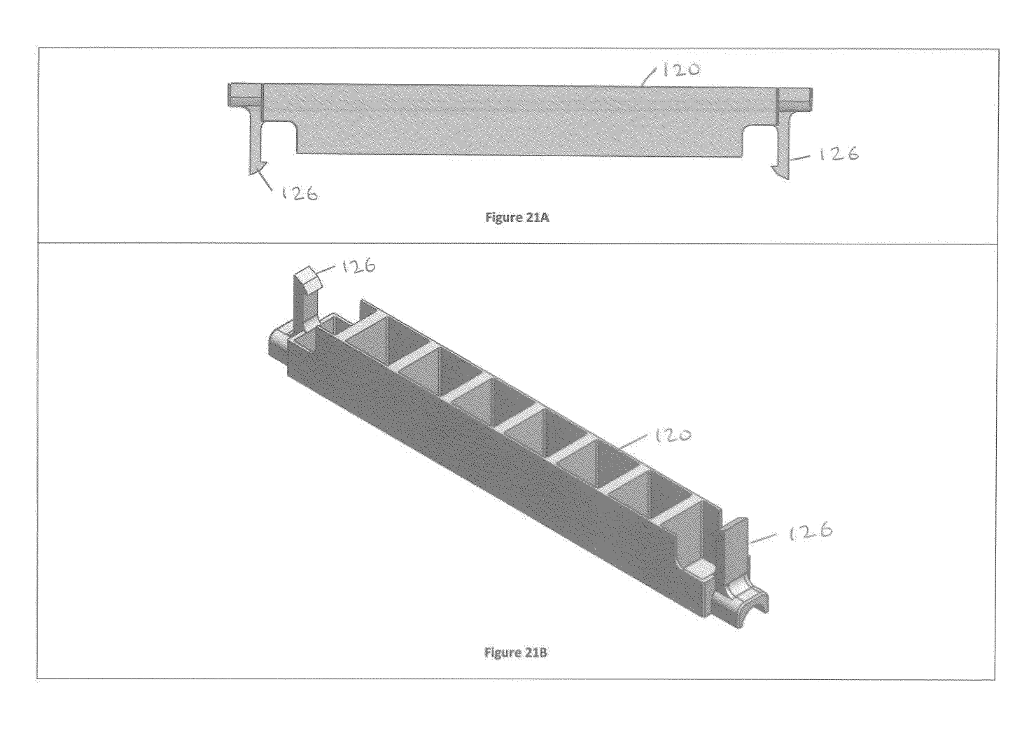

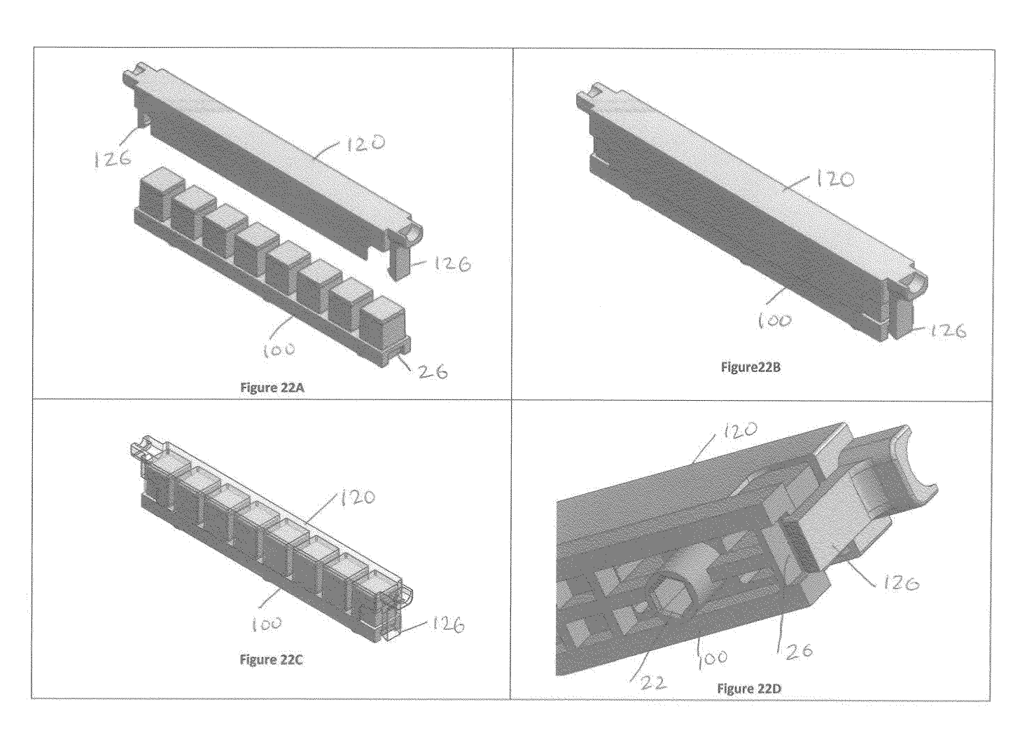

FIGS. 18 A-D, 19A-C and 20A-D show an embodiment in which hexagonal holes on a module are snap-coupled to round pins on the frame to couple modules to the frame. In the example illustrated, each module has three hexagonal holes at the middle and each end of the module, and the frame has 12 columns and 3 rows of round pins. Each column of 3 round pins can couple to and fix in place a module. Thus, in this example, 12 modules can be coupled to the frame thus forming an array of sensors. Of course, different numbers of hexagonal holes can be included in each module (e.g., 1-10) and with corresponding numbers of rows of round pins in the frame. Also the number of columns of round pins can be adjusted to accommodate different numbers of modules in the frame.

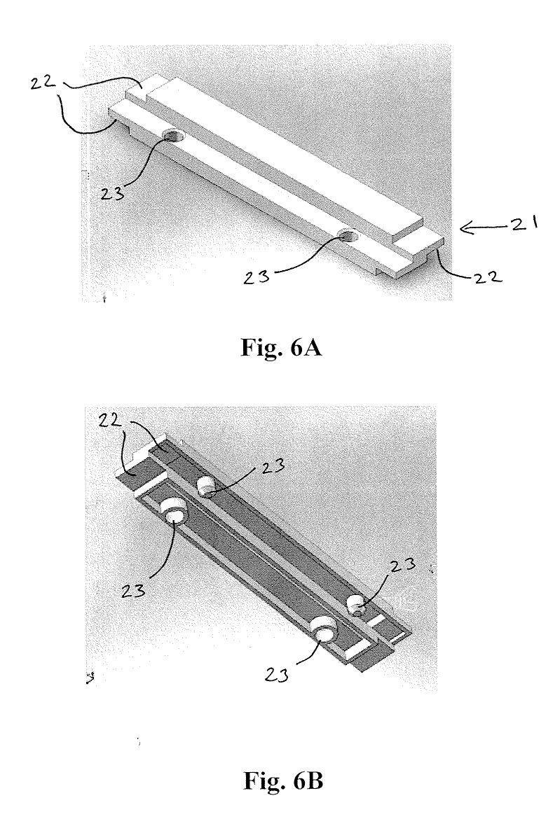

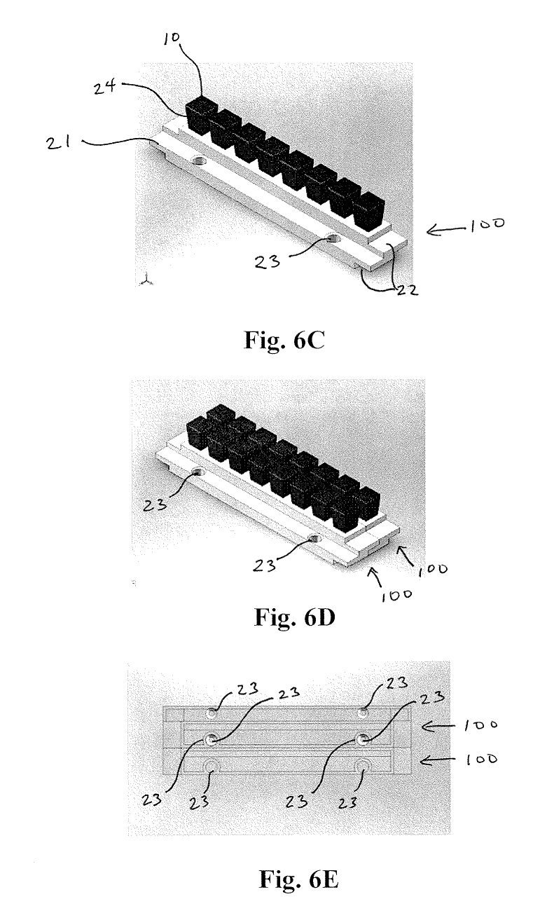

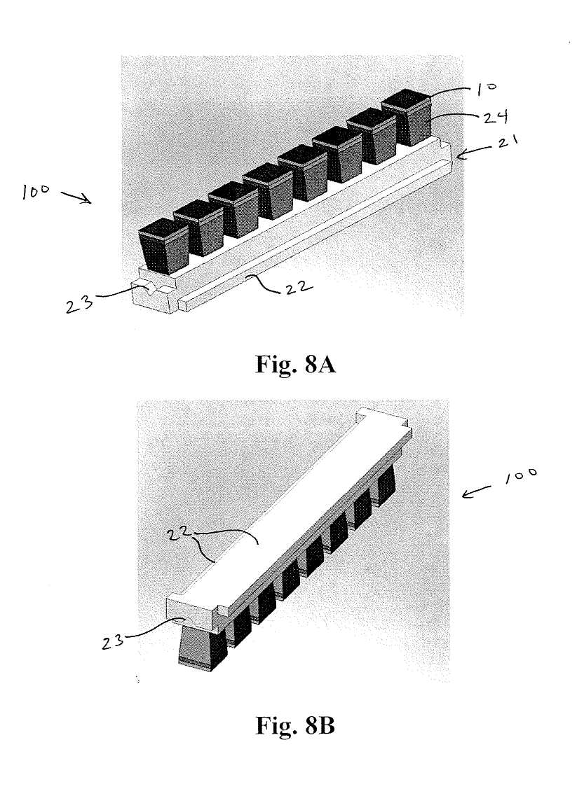

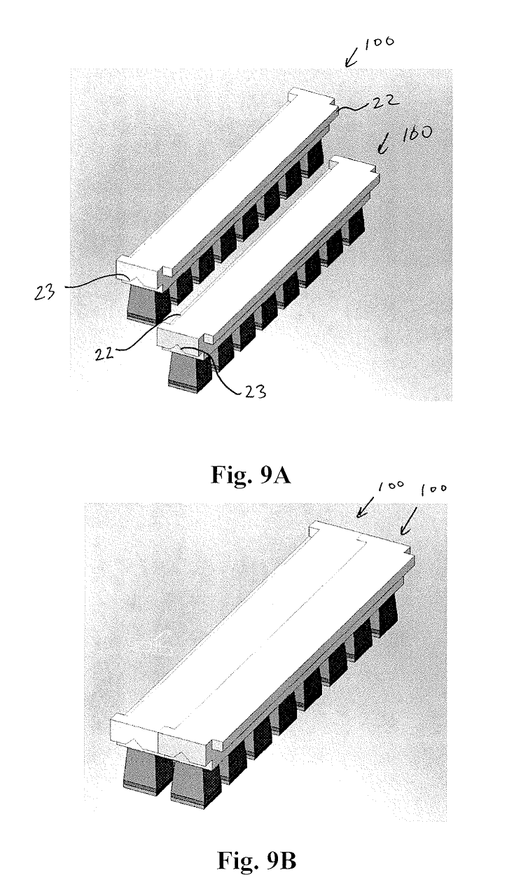

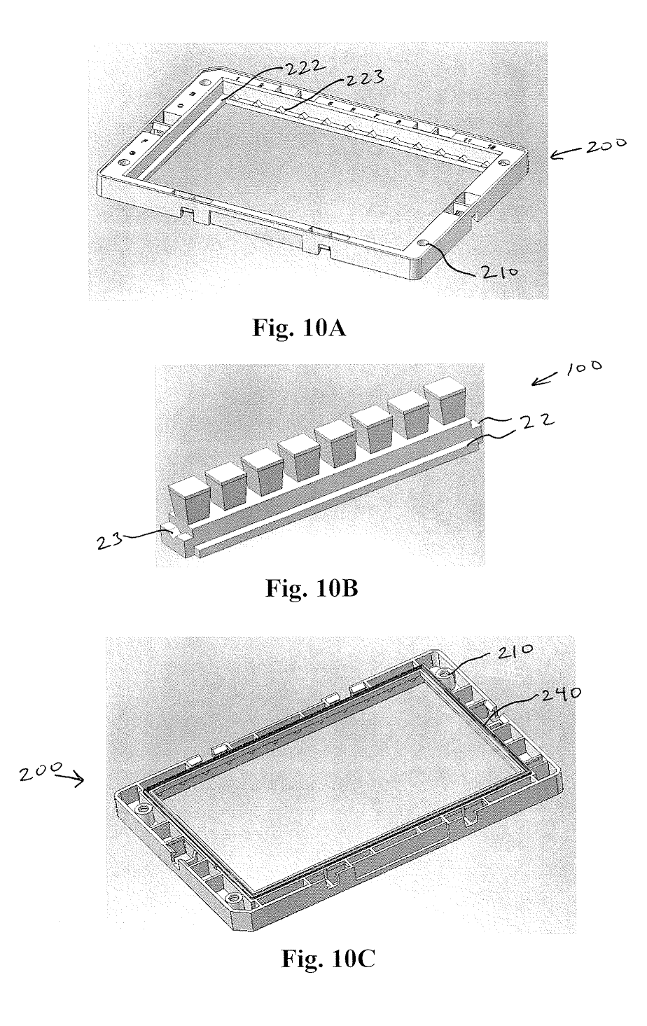

Strips-in-Frame Sensor Modules. In another embodiment of the invention, the coupling surface 22 of the module includes a number of coupling surfaces on a rectangular base portion 21 of a module 100. These coupling surfaces may include the end surfaces of rectangular base 21 or a plurality of surfaces located on tiered, stepped, or undercut portions on base 21. In some embodiments, the tiered portions or undercuts are located on a rectangular base portion 21, as shown in FIGS. 6A-9B, although the base portion may be any shape.

In many embodiments, the coupling surfaces 22 interface with corresponding coupling surfaces of the frame 200 or an adjacent module 100 within the sensor plate 300 to constrain the movement of the module 100 relative to the frame 200. For instance, as shown in FIGS. 6A-6E, the coupling surface may include a top and bottom undercut on each end of the rectangular base portion 21, a top surface lengthwise undercut or step on one side of the base, and a bottom lengthwise undercut along the opposite side of the base. The movement of the module in the y-direction is constrained by nesting the bottom undercuts on each end of base portion 21 onto opposite sides of the frame when the strip module 100 is placed within the corresponding strip frame 100 from above the frame, as shown in FIGS. 7A-7F. The bottom undercut along a length-wise side of the module 100 rests against another member of the frame, which partially constrains the movement of them module 100 in the x-direction. The top undercut on the opposite lengthwise side of the module 100 rests against a corresponding bottom lengthwise undercut of an adjacent module 100, as shown in FIG. 7B, such that when the frame 200 is completely filled with modules 100 movement of the modules 100 is fully constrained in the x-direction. A retaining member 250, comprising a rectangular rim, is placed over the top surface of the frame interfaces with the top undercut at each end of the base portion 21 constraining movement of each module in the z-direction. Acting together, the series of undercuts interface with the members of frame 200 to fully constrain the movement of the modules in a fixed position.

In one embodiment, the alignment feature 23 of the module includes a pair of pins extending downward from the base portion 21, as illustrated in FIG. 6B, and a pair of recesses or holes in an upper surface of the base portion 21, as illustrated in FIG. 6A. The pin alignment feature 23 of the module may interface with either a recess alignment feature 223 of the frame (not shown) or with a recessed alignment feature 23 of an adjacent module 100 in the sensor plate 300, as shown in FIGS. 6D and 6E. When the pair of pins of module 100 is inserted into the pair of recesses of frame 200 or an adjacent module, the module 100 is aligned in the pre-determined alignment relative to the frame.

In another embodiment, the undercuts, comprising the coupling surface 22 of the module 100, are positioned such that the modules 100 are nested from the underside of frame 200, as shown in FIGS. 11A through 11H. In this embodiment, the frame 200 is typically turned over and the modules 100 are upside down when placed or nested into the members of frame 200. As in the previous embodiment, the movement of the modules 10 is constrained by the members of frame 200 including a retaining member 250. In this embodiment, however, the retaining member 250 is a backing attached over the underside of frame 200. The alignment feature 23 includes a v-shaped notch in a top surface of base portion 21. These embodiments may incorporate or interchange coupling surfaces or alignment features from alternate embodiments to attach the modules 100 to the frame 200 so as to form a sensor plate 300.

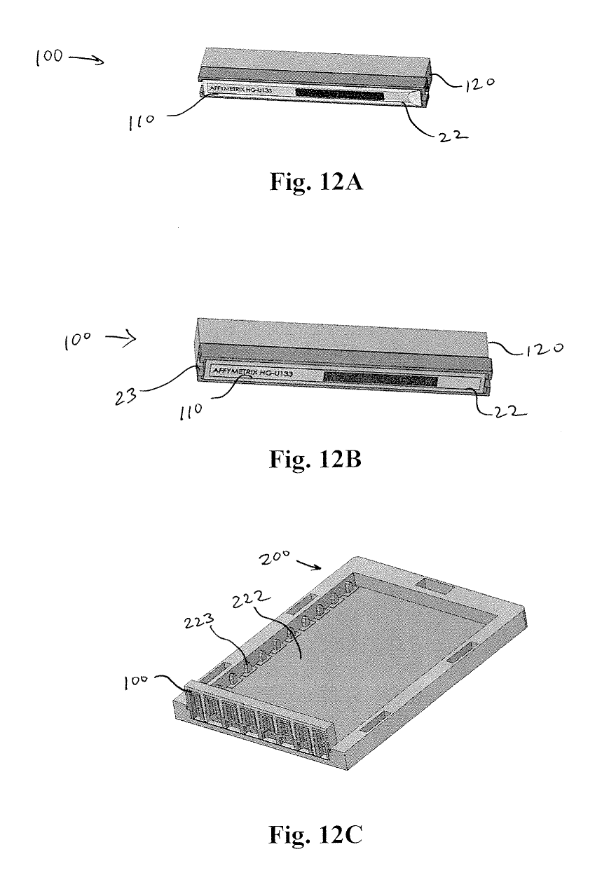

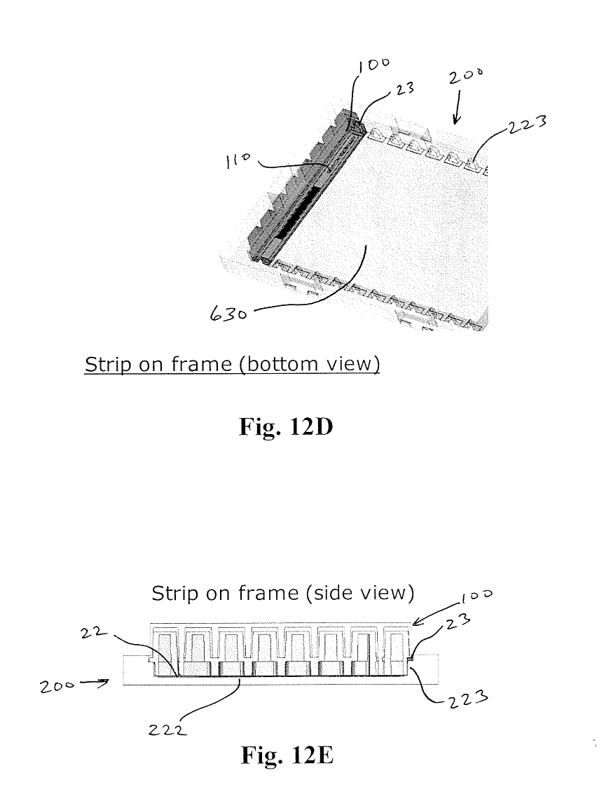

Adhesive Strip Sensor Modules. In an alternative embodiment, the coupling surface 22 includes adhesive strips disposed on a bottom surface of base portion 21 of the sensor module 100, the bottom surface being opposite the sensors 10, as shown in FIGS. 12A-12E, for example. The adhesive sensor module 100 may also include an individual cover 120 and an identification mark 110 located near the adhesive strip coupling surface 22, illustrated in FIGS. 12A and 12B, for example. The individual cover 120 protects the individual sensors to allow for handling of the modules 100 during packaging or assembly. The adhesive coupling surface 22 may include any adhesive capable of attaching module 100 to a surface of the frame, including but not limited to epoxies and pressure-sensitive adhesives. This embodiment may include a protective backing over the adhesive strip to protect and preserve the adhesive layer until the user is ready to attach the module to the frame. In one aspect, the user may remove the backing and press the module against a corresponding coupling surface 222 of the frame into the desired position.

In one embodiment, the adhesive strip sensor module 100 may include an additional alignment feature 23 that interfaces with a corresponding alignment feature 223 of the frame, shown in FIG. 12C. For example, the alignment feature 23 may include a hole or slot in the base portion 21 of the module 100, as shown for example in FIGS. 12A and 12B, corresponding with a protrusion or tab of the frame, as shown for example in FIG. 12C.

In one aspect of the embodiment, frame 200 includes a transparent portion or window 630 to allow for identification of individual modules 100 within the sensor plate by reading of identification mark 110, as shown in FIG. 12D for example. In one embodiment, sensor modules 100 are adhere to a transparent bottom surface of frame 200 such that identification mark 100 on the adhesive strip coupling surface 22 is readily identifiable through the bottom of the frame, shown for example in FIG. 12D.

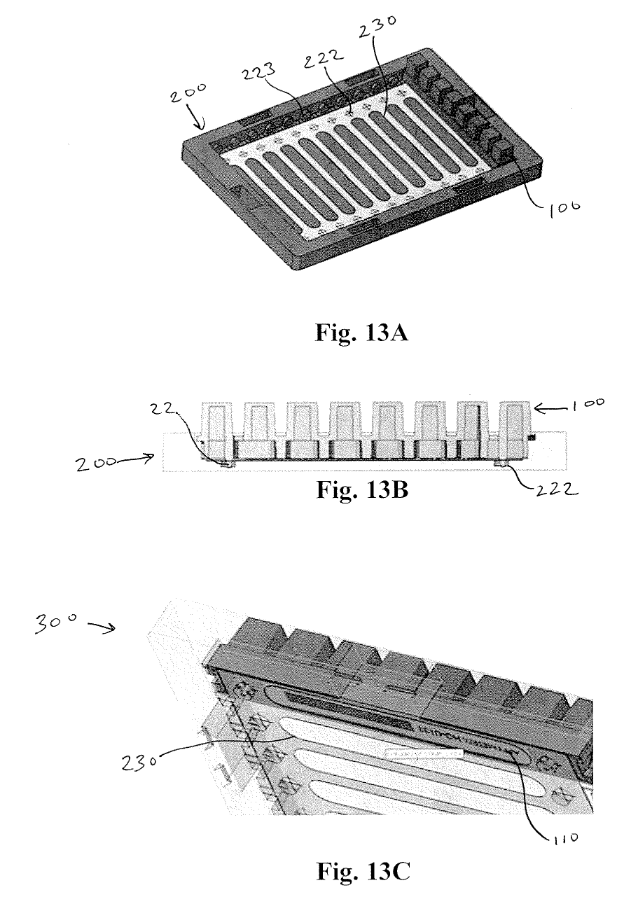

Sensor Modules for use with UV Curable Adhesive. In the embodiment of FIG. 13B, the coupling surface 22 of module 100 includes two pins or protrusions extending downward from the bottom of base portion 21. The pins or protrusions 22 interface with a corresponding coupling surface 222 of the frame 200 comprising two cylindrical recesses fitted to receive the pins. In one embodiment, the cylindrical recess or wells 222 of the frame 200, as shown in FIG. 13B, may be filled with a pliable adhesive, preferably a UV curable adhesive, such that fitting the pins into the wells attaches the modules 100 to the frame 200 once the adhesive is cured. In an embodiment having wells of UV curable adhesive, a portion of the frame 200 may be transparent or translucent to allow for curing of the adhesive through exposure to UV radiation from an LED. For example a portion of the frame 200 near the bottom of the wells may be transparent such that exposing UV radiation to the underside of the frame 200, the side opposite the sensors, cures the adhesive.

In some embodiments, corresponding coupling surfaces of the module 100 and the frame 200 may include protrusions or recesses of any shape, including a coupling surface of one shape that couples to a corresponding surface of a different shape. For example, a round pin may correspond with a hexagonal hole or well, or a hexagonal pin may correspond with a round hole or adhesive-filled well. In certain embodiments, particularly those in which corresponding coupling surfaces of the module 100 and the frame 200 include different shapes, the coupling surfaces experience high interference tolerance permanently fixing the module 100 to the frame 200.

In certain embodiments, the top of the wells are covered with a protective backing to protect and preserve the adhesive until the sensor plate 300 is ready to be assembled. To assembly the modules 100 into a frame 200 having wells containing adhesive, the backing is removed or the pins are pushed through the backing into the wells. Pushing the pins through the backing may reduce exposure of the sensors 10 to outgassing from the adhesive. Additionally, curing the adhesive from the underside the side of the frame 200 opposite the sensor may reduce any harmful effects of UV exposure on the sensors 10. The alignment feature 23 of the module 11 may be incorporated into the coupling surface 23 or may include any of the alignment features described in any alternative embodiments.

In one aspect of the invention, the frame 200 includes windows 630 on the underside of frame 200 to allow for reading of an identification mark 120 on modules 100. For example, a window in the underside of the frame may allow a user to visibly identify an identification mark 120. Alternatively, a user or machine may scan a bar code identification mark 120 on modules 100 through windows 630.

Sensor Plate Assembly. The sensor plates 300 of the claimed invention may be assembled in a variety of different ways. A user or manufacturer may individually assemble the sensor plate 300 by attaching the modules 100 to the frame 200 in the manner discussed in any of the above embodiments. In one aspect of the invention, a user or manufacturer may also utilize a press specifically customized for assembling the above described modular sensor plates 300.

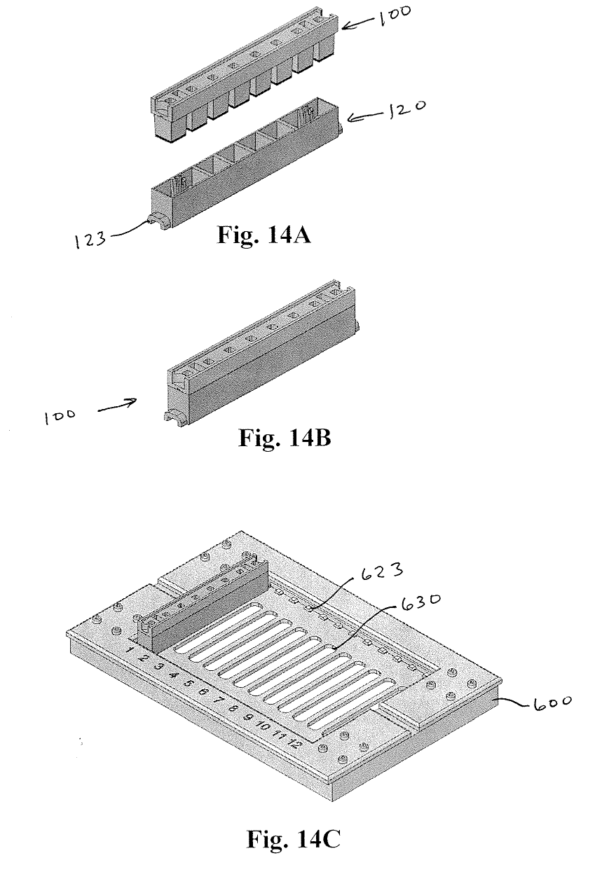

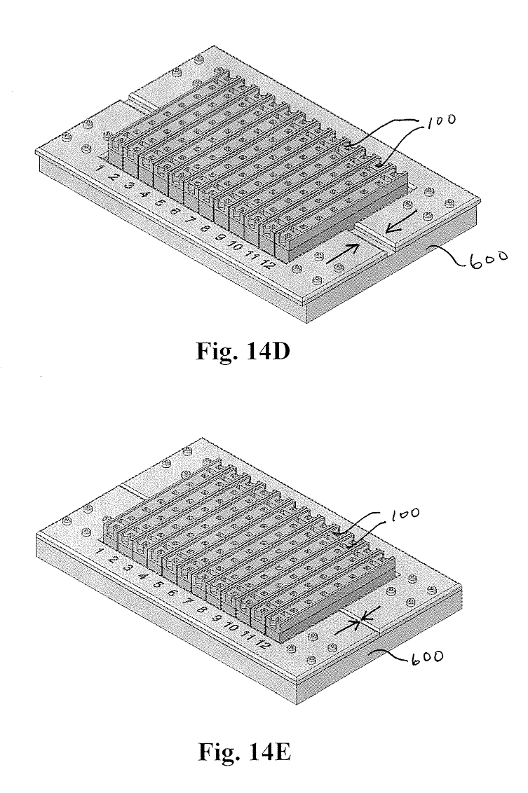

In an embodiment of the invention an assembly press 700 is utilized and the invention further includes an assembly fixture 600. As shown in FIG. 14C, the assembly fixture 600 orients and/or holds the modules 100 in preparation for assembly. In one embodiment, each module 100 includes a protective cover 120. The module 100 may come pre-packaged with the protective cover 120 to protect the sensors 10 during shipping, storage and assembly. The module and protective cover can also be supplied together but unassembled (i.e., copackaged) or separately. The protective cover 120 may include additional alignment features 123, as shown in FIGS. 14A and 14B, to align the modules 100 according to a pre-determined alignment within the fixture. The fixture may also be expandable, so as to allow for easy insertion of the modules into the fixture. Once the modules 100 have been loaded into the fixture, the fixture may contract to further align the modules 100 or constrain the modules in preparation for assembly, for example, as shown in FIGS. 14D and 14E.

The protective cover can be provided with one or more snap-fit coupling surfaces, the same or different from each other, each of which is configured to couple to a corresponding snap-fit surface on the module, thus holding the cover in place on the module until use, when the cover can be removed by the user. FIGS. 21A-B and 22A-D show one such embodiment in which the cover 120 is provided with elongated tabs 126 at opposing ends. In such an embodiment, the module 100 has corresponding notches 26 at its opposing ends that are configured to engage with at least a portion of the tabs 126, thereby holding the cover 120 in place until use. In certain such embodiments, the portion of the tabs that engages with the corresponding notches is inwardly extending, thereby enabling them to engage with the notches while also permitting the remainder of the elongated tabs to be positioned substantially flush adjacent the module.

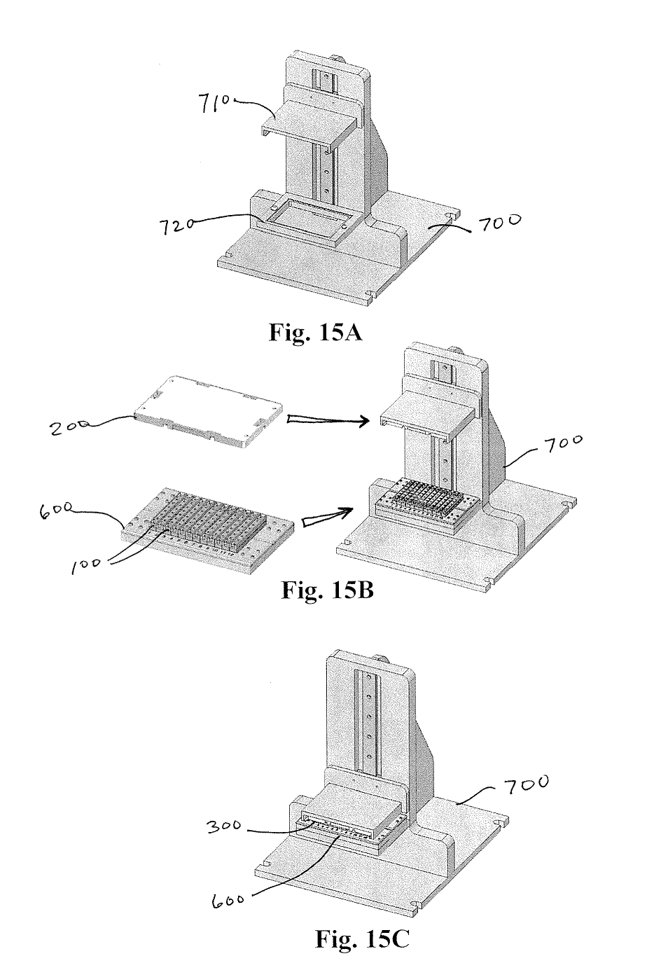

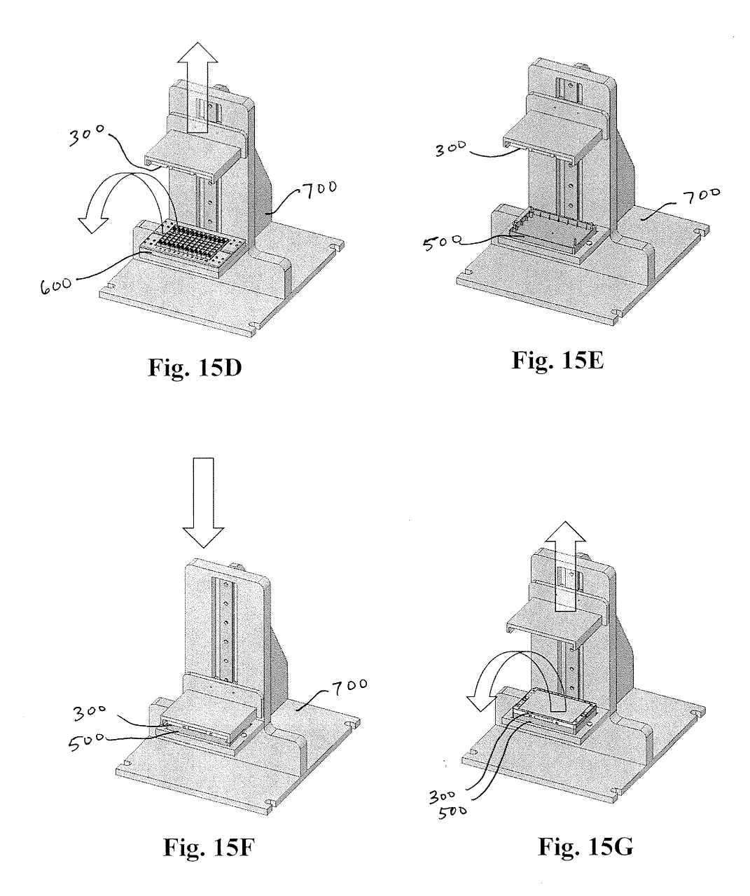

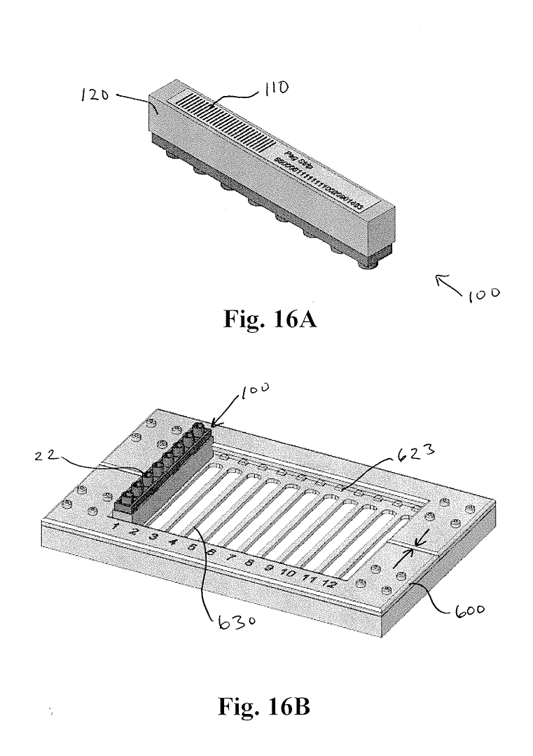

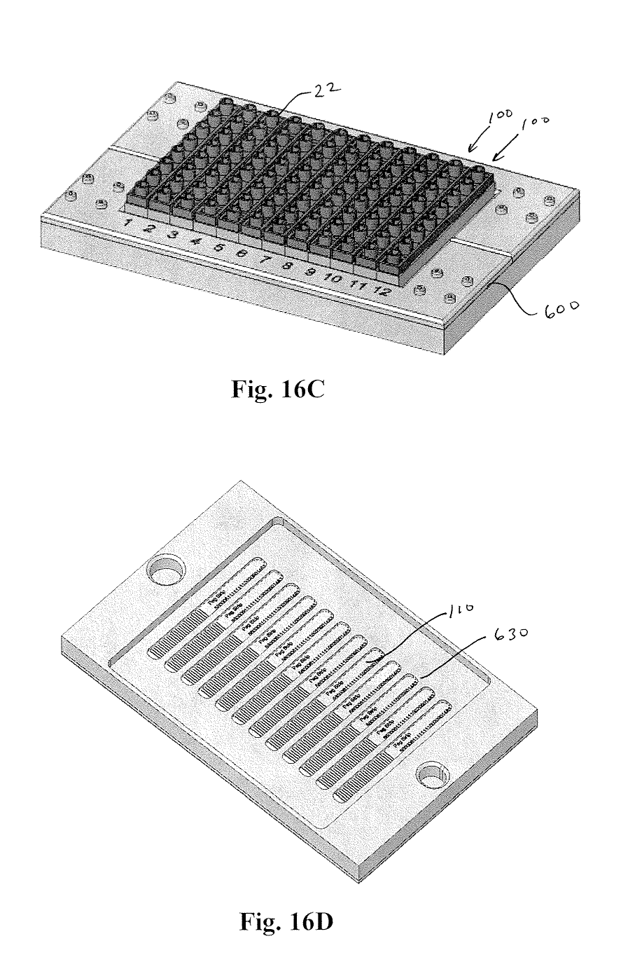

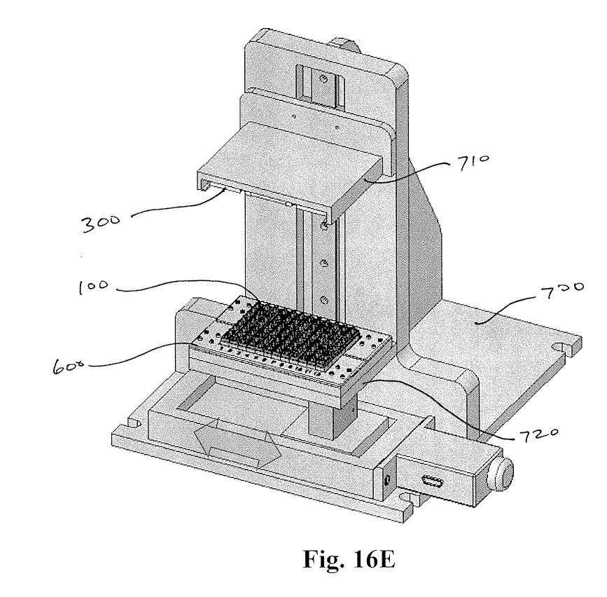

In one embodiment of the invention, the assembly press 700 includes an upper plate 710 and a lower plate 720 that move toward each other to press sensor modules 100 against the frame 200 to fixedly attach the module 100 to the frame. The frame 200 is loaded into upper plate 710, while the fixture 600 containing the aligned modules 100 is loaded onto the lower plate 720, as shown in FIG. 15B. The upper plate 710 is pressed against the lower plate to fixedly attach the modules 100 to the frame 200. The press 700 may be used to assemble various different types of modular sensor plates 300 having various types of coupling surfaces and alignment features, including but not limited to, for example, snap coupling, adhesive strips, and UV curable adhesive wells. The assembly of a snap coupled sensor plate 300 using an assembly press 700 is illustrated in FIGS. 16A and B, for example.

In one embodiment of the invention, a cover 500 is attached to frame 200 to protect the sensor 10 of the sensor plate 300. After the press 710 assembles the sensor plate 300, the upper plate 710 and lower plate 720 are separated. The assembled sensor plate 300 remains loaded in the upper plate 710, while the now empty fixture 600 is removed from lower plate 720. Cover 500 may then be loaded onto the lower plate 720 to be attached to the sensor plate 300 held in upper plate 710. The upper plate 710 is then lowered against lower plate 720 to apply pressure between the sensor plate 300 and cover 500 by which cover 500 is attached to the sensor plate 300. The cover 500 may be attached to the frame 200 by a variety of attachment mechanisms or coupling surface, including but not limited to any of the attachment means described herein. The sensor plate 300 with attached cover 500 is then removed from the press. Attaching a cover 500 to sensor plate 300 allows the sensor plate 300 to be shipped and handled without damaging the sensors 10 of the sensor plate 300. It is also appreciated that cover 500 may be replaced with a processing tray 400 which may also protect the sensors 10 and be useful for assay processing of the sensor plate 300.

In one embodiment of the invention, the press 710 includes a feature to cure an adhesive to attach the modules 100 to the frame 200. This feature may include heating either of the upper or lower plates to facilitate curing of an adhesive once the modules 100 have been pressed against the frame 200 in the fixed aligned position. The curing adhesive may also include a radiation emitting source, such as an LED that emits UV radiation to cure UV curable adhesive, for example.

In another embodiment of the invention, the press 710 includes a reader that reads an identification mark of a module before, during or after assembly. As shown in FIGS. 16C and 16D, the fixture 600 may include transparent portions or windows to allow reading of identification mark 110 through the fixture 600. The assembly press 700 may include a means for identifying a module 100 within a fixture 600 or frame 200. The means for identifying the module 100 may include an optical reader, for instance a bar code scanner, or an RFID detector to detect an RFID signal from an individual module. The identifying means may identify the modules 100 through the fixture 600 when loaded on to the press or may read the identification marks through the underside of the frame. Alternatively, identification mark 110 may be placed on an individual protective cover 120 on a module 100 such that the identifying means may identify the module from either side of the fixture 600 or frame 200.

In another embodiment, frame 200 includes an identification mark 110 readable by either a user or by an identifying feature of the assembly press 700 described above. The user or a computer identifies each of the modules 100 and frame 200 and associates the ID of the frame 200 with each of the modules 100 in the frame 200. This identifying information may be useful in performing the assay and in obtaining and organizing detection results. In another embodiment, the HT analyzer may read and/or associate the frame 200 and individual sensor modules 100 to compile and organize results of the assay. The ID of the frame 200 and/or sensor modules 100 may also contain information as to the protocol of the assay suitable for a given type of sensor 10 or sensor module 100.

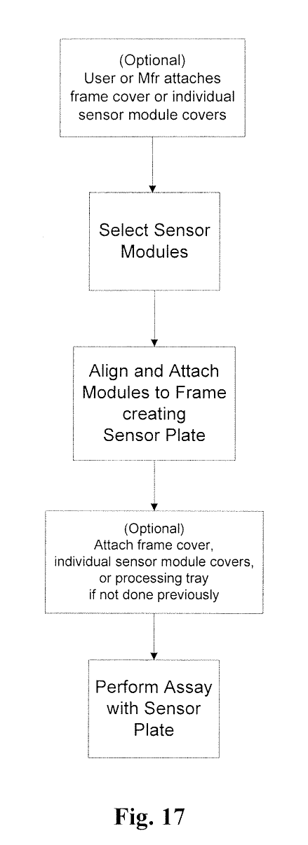

In one aspect of the invention, a user may build a customized sensor plate 300 to suit the user's individual needs. As illustrated in the flow chart in FIG. 17, sensor modules allow a user to perform steps that were traditionally performed by sensor plate manufacturers. The sensor module may already have a cover attached by the manufacturer. Alternatively, the user may attach covers to the individual modules to protect the sensors. Next, the user selects sensor modules according to the user's individual needs. For instance, the user may select one module, 12 identical sensor modules, 12 different sensor modules, a module containing eight different types of sensors, or a module containing eight identical sensors. Alternatively, the user may select a module having one sensor along with one or more modules each having multiple sensors. Typically, the user selects modules with sensors having a compatible assay protocol. Next, the user aligns and attaches the modules to a frame creating a sensor plate. The user may align and attach the modules to the frame using a variety of methods, including but not limited to any of the methods described above or any combination thereof, so long as the sensor of the modules are fixed and aligned to perform an assay protocol. In one embodiment, the user may attach a cover to the individual modules if not done so previously or attach a cover or processing tray to the sensor plate. Preferably, this step is performed soon after creating the sensor plate to protect the sensors if not covered earlier. However, this step may be performed later at the user's discretion or the initial attachment of the processing tray may be one of the steps within performing the assay protocol. Finally, the user performs an assay using the customized sensor plate. Although an assay protocol typically involves staining of the sensors, hybridization, washing, and detection, the protocols may include a variety of different assay processing steps and techniques.

1. A method of assembling a modular array comprising:
selecting a plurality of sensor modules, each sensor module comprising:
a solid support and at least one sensor, wherein the solid support comprises a base portion;
aligning the sensor modules relative to a frame with a pre-determined alignment; and
fixedly attaching the sensor modules to the frame in the pre-determined alignment forming an array of sensors, wherein the frame supports the base portion of each sensor module, the sensor modules positioned along a major plane of the frame, and the sensors of the array protruding from the base portion sufficiently to facilitate dipping each sensor into a separate reservoir of a processor tray.

2. The method of claim 1, further comprising:
affixing a sensor module cover to the sensor module so as to protect the plurality of sensors attached to the solid support.

3. The method of claim 1, further comprising:
affixing a frame cover to the frame so as to protect the plurality of sensor modules fixedly attached to the frame.

4. The method of claim 1, wherein aligning the sensor modules and fixedly attaching the sensor modules are performed in the same action.

5. The method of claim 1, wherein selecting the sensor modules comprises: selecting from among a plurality of differing sensor modules having differing sensors, and wherein the selected sensor modules have differing sensors with a compatible assay protocol.

6. The method of claim 1, wherein the sensors comprise: sensor surfaces, wherein the sensor surfaces of the array are oriented to extend along the plane of the frame.

7. The method of claim 2, wherein attaching the sensor modules to the frame comprises:
snapping the sensor modules to the frame.

8. The method of claim 6, wherein aligning the sensor modules comprises:
engaging an alignment feature of the base portion of each sensor module with a corresponding feature of the frame and/or of the base portion of an adjacent module so as to guide the sensor module into the pre-determined alignment with the frame, wherein the snapping of the sensor module into a desired position relative to the frame resiliently displaces a snap surface, and wherein snapping of the sensor module to the frame is effected by resilient return of the snap surface toward a relaxed configuration so as to hold the sensor module in the desired position and a pre-determined orientation relative to the frame.

9. The method of claim 2, wherein attaching the sensor modules to the frame comprises:
sliding the base portion of the solid support of a first sensor module, the base portion having undercuts, into the frame so as to interface the undercuts with the frame and nest the sensor module within the frame;
sliding the base portion of a second module into the frame, so as to interface the undercuts of the second module with the frame and/or the first sensor module; and
attaching a retaining member to the frame to constrain movement of the sensor modules in a direction traversing the major plane of the frame.

10. The method of claim 8, wherein aligning the sensor modules comprise interfacing a pair of protrusions on the solid support of a module into a pair of recesses disposed on the frame and/or on the solid support of an adjacent module.

11. The method of claim 8, wherein attaching a retaining member to the frame comprises:
attaching a rim over a top surface of the frame or attaching a backing to an underside of the frame.

12. The method of claim 2, wherein attaching the sensor modules to the frame comprises:
adhering each module to the frame with an adhesive.

13. The method of claim 12, wherein aligning the sensor modules comprises:
interfacing at least one protrusion on the base portion of the solid support of a sensor module into a recess disposed on the frame.

14. The method of claim 12, wherein attaching the sensor module to the frame further comprises:
peeling off an adhesive backing to expose an adhesive layer and then adhering the sensor module to the frame by applying a pressure to the adhesive backing against a surface of the frame.

15. The method of claim 2, wherein attaching the sensor modules to the frame comprises:
adhering a sensor module to the frame with an UV curable adhesive; and
curing the adhesive by exposing the adhesive to UV radiation.

16. The method of claim 15, wherein attaching the sensor module to the frame comprises:
inserting a plurality of protrusions of the base portion of the support of the sensor module into a plurality of sealed wells of the frame by puncturing the seals, wherein the wells contain a UV curable adhesive; and
exposing the UV curable adhesive to UV light so as to fix the sensor module into the pre-determined alignment.

17. The method of claim 16, wherein inserting the protrusions of the sensor module into the wells of the frame comprises:
penetrating the adhesive between the frame and the base portion of the sensor module.

18. An array assembly for use with an automated sensor array analyzer and a processing tray, the assembly comprising:
a plurality of sensor modules, each sensor module comprising a plurality of sensors and a solid support, wherein the solid support comprises:
a base portion having coupling surface;
a frame engageable with the plurality of sensor modules, the sensor modules fittingly receivable by the frame such that the sensor modules are fixedly attached to the frame with a pre-determined alignment relative to the frame by the coupling surface, each sensor of the fixedly attached sensor modules extending along a major plane of the frame and disposed on a portion of the solid support protruding from the base portion sufficiently so as to facilitate dipping of the sensor into a processing tray having separate reservoirs such that each sensor contacts a fluid in a separate reservoir.

19. (canceled)

20. The assembly of claim 18, wherein for each sensor module, the support comprises:
a base portion including the coupling surface, the base portion substantially defining a rectangular prism having a top surface and a bottom surface, and wherein the plurality of sensors protrude from the top surface at regular intervals along an axis of the top surface in a linear array, the plurality of sensor modules being affixed together relative to the axes of the sensor modules, by the frame such that the plurality of sensor modules form a rectangular array of sensors.

21. The assembly of claim 20, wherein the sensors of adjacent sensor modules form a linear array of sensors, adjacent sensors in the linear array having a space between sensors.

22-23. (canceled)

24. The assembly of claim 20, the generally rectangular frame being engageable with 12 sensor modules, each sensor module having 8 sensors, such that the 12 sensor modules coupled to the frame form a 96 sensor rectangular array.

25. The assembly of claim 23, wherein the sensor modules are dimensioned such that the plurality of sensor modules coupled to the frame in the pre-determined alignment form a two-dimensional array of sensors, having an x-axis and a y-axis, adjacent sensors along the x-axis having a space between sensors and adjacent sensors along the y-axis having a space between sensors.

26. (canceled)

27. The assembly of claim 20, wherein each of the plurality of sensors is disposed on a portion of the solid support that protrudes a distance from the base portion of the solid support, wherein the distance is a range from about 1 mm to 30 mm.

28-29. (canceled)

30. The assembly of claim 18, wherein the sensor comprises:
a probe, an array of probes, or a microarray chip.

31. The assembly of claim 18, wherein the coupling surface when coupled to the frame both aligns the sensor module in the pre-determined alignment and couples the sensor module to the frame so as to fixedly attach the sensor module in the pre-determined alignment.

32. The assembly of claim 18, wherein the base portion of the solid support further comprises:
an alignment feature engageable with the frame such that engaging the alignment feature with the frame aligns the sensor module.

33. The assembly of claim 18, wherein the coupling surface is releasable.

34. The assembly of claim 18, wherein the coupling surface comprises:
a plurality of coupling surfaces that when acting together constrain the movement of the sensor module relative to the frame in a x, y, and z-direction so as to fix the sensor module in the pre-determined alignment.

35. The assembly of claim 18, wherein the coupling surface comprises:
a snap engageable with a surface of the frame so as to snap the sensor module to the frame.

36. The assembly of claim 35 wherein the coupling surface of the sensor module is one or more hexagonal holes engageable with one or more round pins on the surface of the frame so as to snap the sensor module to the frame, or wherein the coupling surface of the sensor module is one or more round pins engageable with one or more hexagonal holes on the surface of the frame so as to snap the sensor module to the frame.

37-63. (canceled)

64. The method of claim 3, wherein the cover has tabs at each end engageable with corresponding notches of the sensor module to snap the cover to the sensor module.

65-87. (canceled)
